(19) United States
(12) Patent Application Publication
(10) Pub. No.: US 2023/0338922 A1
(43) Pub. Date: Oct. 26, 2023

(54) High-Performance Metal-Organic Frameworks As Methane Sorbents And Computational Identification Methods

(71) Applicant: THE REGENTS OF THE UNIVERSITY OF MICHIGAN, Ann Harbor, MI (US)

(72) Inventors: Donald Jason SIEGEL, Austin, TX (US); Alauddin AHMED, Ann Arbor, MI (US); Karabi NATH, Ann Arbor, MI (US); Adam MATZGER, Ann Arbor, MI (US)

(73) Assignee: THE REGENTS OF THE UNIVERSITY OF MICHIGAN, Ann Arbor, MI (US)

(21) Appl. No.: 18/134,658

(22) Filed: Apr. 14, 2023

Related U.S. Application Data
(60) Provisional application No. 63/331,559, filed on Apr. 15, 2022.

(51) Int. Cl. B01J 20/28; B01J 20/32; B01J 20/22

(52) U.S. Cl. CPC B01J 20/223; B01J 20/28011; B01J 20/28066; B01J 20/28076; B01J 20/3246

(57) ABSTRACT

A natural gas storage material is provided that comprises a porous metal-organic framework (MOF) material having one or more sites for reversibly storing natural gas that contains methane. In certain variations, the MOF has a usable methane storage capacity of greater than or equal to about 208 cm³(STP)/cm³ under pressure swing conditions of 80 bar adsorption to 5 bar desorption at 298 K. In other variations, suitable MOFs having one or more sites for reversibly storing methane with advantageous natural gas storage capabilities are selected from the group consisting of: UMCM-152, DUT-23-Cu, VEBHUG_SL, FUYCIN, ja074366osi20070816_031204, XIYYEL, cg500192d_si_003, VUSKAW, VUSKEA, PEVQOY, EDUSIF, and combinations thereof. Natural gas storage systems and methods of reversibly storing natural gas in such MOFs are also provided.

### GOVERNMENT SUPPORT

This invention was made with government support under DE-EE0008814 awarded by the Department of Energy. The Government has certain rights in the invention.

### CROSS-REFERENCE TO RELATED APPLICATIONS

This application claims the benefit of U.S. Provisional Application No. 63/331,559, filed on Apr. 15, 2022. The entire disclosure of the above application is incorporated herein by reference.

### FIELD

The present disclosure relates to a natural gas storage material comprising a porous metal-organic framework (MOF) material having one or more sites for reversibly storing methane. In certain variations, the MOF has a usable methane storage capacity of greater than or equal to about 208 cm³(STP)/cm³ under pressure swing conditions of 80 bar adsorption to 5 bar desorption at 298 K. Natural gas storage systems and methods of reversibly storing natural gas in such MOFs are also provided.

### BACKGROUND

This section provides background information related to the present disclosure which is not necessarily prior art.

Natural gas is often cited as an important stepping-stone in the transition to low-carbon transportation fuels. Natural gas (NG) is a mixture of methane (CH₄) and other hydrocarbon gases, such as ethane (C₂H₆), propane (C₃Hs), butane (C₄H₁₀), isobutene (C₄H₈), and pentane (C₅H₁₂). Prior to refinement, raw natural gas may also contain water vapor, hydrogen sulfide (H₂S), carbon dioxide, nitrogen, helium, and other impurities, such as mercury. A typical natural gas can comprise greater than or equal to about 75 mol. % of methane, for example, optionally greater than or equal to about 90 mol. % to less than or equal to about 98 mol. % methane. Natural gas may also comprise greater than or equal to about 1.5 mol. % to less than or equal to about 9 mol. % ethane, optionally greater than or equal to about 0.1 mol. % to less than or equal to about 1.5 mol. % propane, optionally less than or equal to about 0.5 mol. % butane, optionally greater than or equal to about 0.2 mol. % to less than or equal to about 5.5 mol. % nitrogen, optionally greater than or equal to about 0.05 mol. % to less than or equal to about 1 mol. % carbon dioxide, optionally less than or equal to about 0.1 mol. % oxygen, by way of example.

Thus, natural gas, comprising methane as the primary component, is an attractive gasoline alternative on account of its wide availability, established distribution network, high hydrogen to carbon ratio, and moderate carbon emissions. However, the low density of NG presents challenges for its storage that limit energy density and impede broad deployment in mobile applications such as vehicles. Particularly, the volumetric energy density of NG, which impacts the driving range of a vehicle, is much lower than that of gasoline: uncompressed NG has an energy density of 0.04 MJ/L, while gasoline exhibits a value of 32.4 MJ/L.

Physical approaches to improve volumetric storage density include storing and delivering natural gas as compressed natural gas (CNG), liquefied natural gas (LNG), and adsorbed natural gas (ANG). For CNG, natural gas may be stored at relatively high pressures, for example, about 250 bar (3,500 psi, high pressures where compressed natural gas has an energy density of approximately 9 MJ/L) in tanks and delivered as a fuel. However, the cost of compressing natural gas can be high. CNG requires the use of bulky and expensive fuel tanks, and multistage compressors. Further, in certain applications, like vehicles, carrying a highly pressurized tank raises safety concerns in case of accidents and provides a diminished driving range as compared to gasoline. LNG involves liquefaction at low temperatures (approximately 110 K, where liquefied natural gas, LNG has an energy density of about 22.2 MJ/L). LNG allows for lower pressures but has the drawbacks of complex tank designs and pressure buildup upon extended storage. LNG likewise has a high cost associated with liquefaction.

Adsorbed natural gas (ANG) is a promising alternative to compression/CNG and liquefaction/LNG. Adsorbents can potentially store NG at high densities at modest pressures (approximately 35-80 bar), which translates to less costly tank designs. Thus, the presence of sorbents in ANG technology reduces the pressure requirements in storage vessels/tanks, reducing the safety concerns in vehicles and need for extensive pressurization. Various sorbent materials have been tested for ANG storage, including activated carbons, zeolites, porous coordination polymers, and metal-organic frameworks. These materials have shown promise in their ability to adsorb and desorb natural gas, and in particular methane contained in natural gas. However, various adsorbents have different storage capacities.

MOFs with high porosity, high surface area, and tunability in structure have emerged as promising materials for ANG. The most common proxy for ANG performance is methane storage capacity. For vehicular applications, a suitable adsorbent ideally exhibits a combination of high methane uptake at the maximum (filled state) storage pressure (about 65 or about 80 bar) with low uptake at the minimum desorption pressure (about 5 bar), resulting in a high usable capacity (residual gas stored at pressures below 5 bar is insufficient to power an internal combustion engine). The usable (or deliverable) uptake/storage capacity should be distinguished from total uptake/storage capacity. The former is a practical metric of performance, whereas the latter represents the maximum gas stored at high pressure and does not account for any residual gas present at low pressures.

Among the many possible MOFs, HKUST-1 is commonly cited as a benchmark methane adsorbent, given its high total methane capacity (267 cm³ (STP) cm⁻³ at 65 bar and 272 cm³ (STP) cm⁻³ at 80 bar) and excellent deliverable capacity (190 cm³ (STP) cm⁻³ (a usable methane storage capacity of about 190 cm³ (STP) adsorbed at 65 bar and desorbed at 5 bar) and 200 cm³ (STP) cm⁻³ (80-5 bar)). HKUST-1 (HKUST = Hong Kong University of Science and Technology) is a MOF with Cu₂(-COO)₄ secondary building units having a paddle wheel shape and a surface area of about 1,800 m²/g commercially available as BASOLITE C300™. However, it is a continuing goal to find MOFs that provide even higher natural gas storage capacity. Tens of thousands of MOFs have been synthesized (and even more theoretical potential MOFs are yet to be synthesized), yet only a fraction have been examined experimentally as methane sorbents. It is desirable to identify additional MOFs with superior natural gas storage capabilities to HKUST-1 to serve as a natural gas storage material for ANG technology.

### SUMMARY

This section provides a general summary of the disclosure, and is not a comprehensive disclosure of its full scope or all of its features.

In certain aspects the present disclosure relates to a natural gas storage material. The natural gas storage material may comprise a porous metal-organic framework material having one or more sites for reversibly storing methane and having a usable methane storage capacity of greater than or equal to about 208 cm³(STP)/cm³ under pressure swing conditions of 80 bar adsorption to 5 bar desorption at 298 K.

In certain aspects, the porous metal-organic framework material has a gravimetric surface area of greater than or equal to about 2,000 m²/g.

In certain aspects, the porous metal-organic framework material has a pore volume of greater than or equal to about 1 cm³/g to less than or equal to about 2.2 cm³/g.

In certain aspects, the porous metal-organic framework material comprises pores having an average pore diameter of greater than or equal to about 7 Angstrom to less than or equal to about 20 Angstrom.

In certain aspects, the porous metal-organic framework material has a volumetric surface area of greater than or equal to about 1,800 m²/cm³ to less than or equal to about 2,700 m²/cm³.

In certain aspects, the porous metal-organic framework material has a single crystal density of greater than or equal to about 0.4 g/cm³ to less than or equal to about 1 g/cm³.

In certain aspects, the porous metal-organic framework material has a void fraction of greater than or equal to about 0.7 to less than or equal to about 0.85.

In certain aspects, the porous metal-organic framework material is catena-((µ8-5-(3,5-bis(4-carboxyphenyl)phenyl)benzene-1,3-dicarboxylato)-diaqua-di-copper](UMCM-152).

In certain aspects, the porous metal-organic framework material is catena-(tetrakis(µ6-benzene-1,3,5-tribenzoate)-tris(µ2-4,4′-bipyridine)-hexa-copper) (DUT-23-Cu).

In certain aspects, the usable methane storage capacity is greater than or equal to about 216 cm³(STP)/cm³.

In certain aspects, the usable methane storage capacity is greater than or equal to about 226 cm³(STP)/cm³.

In certain aspects, wherein the metal-organic framework is activated by treatment with supercritical carbon dioxide (CO₂).

In certain aspects, the gas comprises a mixture of methane and at least one other gas.

In certain further aspects, the gas is derived from natural gas.

In certain aspects the present disclosure relates to a natural gas storage material. The natural gas storage material may comprise a porous metal-organic framework material having one or more sites for reversibly storing methane selected from the group consisting of: catena-((µ8-5-(3,5-bis(4-carboxyphenyl)phenyl)benzene-1,3-dicarboxylato)-diaqua-di-copper](UMCM-152), catena-(tetrakis(µ6-benzene-1,3,5-tribenzoate)-tris(µ2-4,4′-bipyridine)-hexa-copper) (DUT 23 Cu), catena-[(µ4-Oxo)-tris(µ4-thieno[3,2-b]thiophene-2,5-dicarboxylato)-tetra-zinc] (VEBHUG or IRMOF-20), catena-[bis(dimethylammonium) (µ-triphenylene-2,3,6,7,10,11-hexolato)-vanadium dihydrate] (FUYCIN or V-CAT-5), catena-[(m-oxido)-tris(m-benzene-1,4-dicarboxylato)-tetra-zinc(ii)] (ja074366osi20070816_031204 or IRMOF-3), catena-[hexakis(dimethylammonium) disulfate tris(m2-oxalato)-di-zinc] (XIYYEL), bis(m2-N′-(3-hydroxy-2-oxybenzylidene)-2-hydroxybenzohydrazide)-tetrakis(pyridine)-di-manganese dinitrate methanol solvate (cg500192d_si_003 or porph@MOM-13), catena-(hexakis(m4-Benzene-1,4-dicarboxylato)-bis(m4-oxo)-octa-zinc solvate trihydrate (VUSKAW or MOF-5), catena-(hexakis(m4-Benzene-1,4-dicarboxylato)-bis(m4-oxo)-octa-zinc solvate) (VUSKEA or MOF-5), catena-(tris(m7-2,2′-(Adipoylbis(azanediyl))diterephthalato)-bis(m4-oxo)-octa-zinc chloroform dimethylformamide solvate) (PEVQOY or IRMOF-3-AM4XL), catena-(tris(m4-Benzene-1,4-dicarboxylato)-(m4-oxo)-tetra-zinc heptakis(N,N-diethylformamide) trihydrate clathrate) (EDUSIF or MOF-5), and combinations thereof.

In certain aspects, the porous metal-organic framework material is selected from the group consisting of: catena-[bis(dimethylammonium) (µ-triphenylene-2,3,6,7,10,11-hexolato)-vanadium dihydrate] (FUYCIN or V-CAT-5), and combinations thereof.

In certain aspects, the porous metal-organic framework material is selected from the group consisting of: catena-((µ8-5-(3,5-bis(4-carboxyphenyl)phenyl)benzene-1,3-dicarboxylato)-diaqua-di-copper] (UMCM-152), catena-(tetrakis(µ6-benzene-1,3,5-tribenzoate)-tris(µ2-4,4′-bipyridine)-hexa-copper) (DUT 23 Cu), catena-[(µ4-Oxo)-tris(µ4-thieno[3,2-b]thiophene-2,5-dicarboxylato)-tetra-zinc] (VEBHUG or IRMOF-20), catena-[bis(dimethylammonium) (µ-triphenylene-2,3,6,7,10,11-hexolato)-vanadium dihydrate] (FUYCIN or V-CAT-5), catena-[(m-oxido)-tris(m-benzene-1,4-dicarboxylato)-tetra-zinc(ii)] (ja074366osi20070816_031204 or IRMOF-3), catena-[hexakis(dimethylammonium) disulfate tris(m2-oxalato)-di-zinc] (XIYYEL), bis(m2-N′-(3-hydroxy-2-oxybenzylidene)-2-hydroxybenzohydrazide)-tetrakis(pyridine)-di-manganese dinitrate methanol solvate (cg500192d_si_003 or porph@MOM-13), catena-(hexakis(m4-Benzene-1,4-dicarboxylato)-bis(m4-oxo)-octa-zinc solvate trihydrate (VUSKAW or MOF-5), catena-(hexakis(m4-Benzene-1,4-dicarboxylato)-bis(m4-oxo)-octa-zinc solvate) (VUSKEA or MOF-5), catena-(tris(m7-2,2′-(Adipoylbis(azanediyl))diterephthalato)-bis(m4-oxo)-octa-zinc chloroform dimethylformamide solvate) (PEVQOY or IRMOF-3-AM4XL), catena-(tris(m4-Benzene-1,4-dicarboxylato)-(m4-oxo)-tetra-zinc heptakis(N,N-diethylformamide) trihydrate clathrate) (EDUSIF or MOF-5), and combinations thereof.

In certain aspects, the porous metal-organic framework material is selected from the group consisting of: catena-((µ8-5-(3,5-bis(4-carboxyphenyl)phenyl)benzene-1,3-dicarboxylato)-diaqua-di-copper](UMCM-152), catena-(tetrakis(µ6-benzene-1,3,5-tribenzoate)-tris(µ2-4,4′-bipyridine)-hexa-copper) (DUT-23-Cu), catena-[(µ4-Oxo)-tris(µ4-thieno[3,2-b]thiophene-2,5-dicarboxylato)-tetra-zinc] (VEBHUG or IRMOF-20), catena-[bis(dimethylammonium) (µ-triphenylene-2,3,6,7,10,11-hexolato)-vanadium dihydrate] (FUYCIN or V-CAT-5), catena-[(m-oxido)-tris(m-benzene-1,4-dicarboxylato)-tetra-zinc(ii)] (ja074366osi20070816_031204 or IRMOF-3), catena-[hexakis(dimethylammonium) disulfate tris(m2-oxalato)-di-zinc] (XIYYEL), catena-(hexakis(m4-Benzene-1,4-dicarboxylato)-bis(m4-oxo)-octa-zinc solvate) (VUSKEA or MOF-5), catena-(tris(m7-2,2′-(Adipoylbis(azanediyl))diterephthalato)-bis(m4-oxo)-octa-zinc chloroform dimethylformamide solvate) (PEVQOY or IRMOF-3-AM4XL), and combinations thereof.

In certain aspects, the porous metal-organic framework material is selected from the group consisting of: catena-((µ8-5-(3,5-bis(4-carboxyphenyl)phenyl)benzene-1,3-dicarboxylato)-diaqua-di-copper] (UMCM-152), catena-(tetrakis(µ6-benzene-1,3,5-tribenzoate)-tris(µ2-4,4′-bipyridine)-hexa-copper) (DUT 23 Cu), and combinations thereof.

In certain aspects the present disclosure relates to a natural gas storage system that comprises a vessel having at least one port for fluid communication and a storage cavity. A porous metal-organic framework material is disposed in storage cavity of the vessel. The porous metal-organic framework material has one or more sites for reversibly storing methane and having a usable methane storage capacity of greater than or equal to about 208 cm³(STP)/cm³ under pressure swing conditions of 80 bar adsorption to 5 bar desorption at 298. The porous metal-organic framework material is capable of reversibly storing a gas comprising methane via adsorption and desorption within the storage cavity of the vessel.

In certain aspects, the porous metal-organic framework material has a gravimetric surface area of greater than or equal to about 2,000 m²/g.

In certain aspects, the porous metal-organic framework material has a pore volume of greater than or equal to about 1 cm³/g to less than or equal to about 2.2 cm³/g.

In certain aspects, the porous metal-organic framework material comprises pores having an average pore diameter of greater than or equal to about 7 Angstrom to less than or equal to about 20 Angstrom.

In certain aspects, the porous metal-organic framework material has a volumetric surface area of greater than or equal to about 1,800 m²/cm³ to less than or equal to about 2,700 m²/cm³.

In certain aspects, the porous metal-organic framework material has a single crystal density of greater than or equal to about 0.4 g/cm³ to less than or equal to about 1 g/cm³.

In certain aspects, the porous metal-organic framework material has a void fraction of greater than or equal to about 0.7 to less than or equal to about 0.85.

In certain aspects, the porous metal-organic framework material is catena-((µ8-5-(3,5-bis(4-carboxyphenyl)phenyl)benzene-1,3-dicarboxylato)-diaqua-di-copper](UMCM-152).

In certain aspects, the porous metal-organic framework material is catena-(tetrakis(µ6-benzene-1,3,5-tribenzoate)-tris(µ2-4,4′-bipyridine)-hexa-copper) (DUT-23-Cu).

In certain aspects, the usable methane storage capacity is greater than or equal to about 216 cm³(STP)/cm³.

In certain aspects, the usable methane storage capacity is greater than or equal to about 226 cm³(STP)/cm³.

In certain aspects, the metal-organic framework is activated by treatment with supercritical carbon dioxide (CO₂).

In certain aspects, the gas comprises a mixture of methane and at least one other gas.

In certain further aspects, the gas is derived from natural gas.

In yet other aspects, the present disclosure relates to a method of reversibly storing a gas comprising methane. The method comprises contacting the gas comprising methane with a porous metal-organic framework material having one or more sites for reversibly storing methane and having a methane storage capacity of greater than or equal to about 208 cm³(STP)/cm³ under pressure swing conditions of 80 bar adsorption to 5 bar desorption at 298 K. The contacting occurs where a first pressure is greater than or equal to about 65 bar for adsorbing methane molecules on the one or more sites.

In certain aspects, the contacting occurs where the first pressure is greater than or equal to about 80 bar.

In certain aspects, the method further comprises releasing the gas comprising methane by desorption from the porous metal-organic framework material by reducing to a second pressure of less than or equal to about 5 bar.

In certain aspects, the porous metal-organic framework material has a gravimetric surface area of greater than or equal to about 2,000 m²/g.

In certain aspects, the porous metal-organic framework material has a pore volume of greater than or equal to about 1 cm³/g to less than or equal to about 2.2 cm³/g.

In certain aspects, the porous metal-organic framework material comprises pores having an average pore diameter of greater than or equal to about 7 Angstrom to less than or equal to about 20 Angstrom.

In certain aspects, the porous metal-organic framework material has a volumetric surface area of greater than or equal to about 1,800 m²/cm³ to less than or equal to about 2,700 m²/cm³.

In certain aspects, the porous metal-organic framework material has a single crystal density of greater than or equal to about 0.4 g/cm³ to less than or equal to about 1 g/cm³.

In certain aspects, the porous metal-organic framework material has a void fraction of greater than or equal to about 0.7 to less than or equal to about 0.85.

In certain aspects, the porous metal-organic framework material is catena-((µ8-5-(3,5-bis(4-carboxyphenyl)phenyl)benzene-1,3-dicarboxylato)-diaqua-di-copper](UMCM-152).

In certain aspects, the porous metal-organic framework material is catena-(tetrakis(µ6-benzene-1,3,5-tribenzoate)-tris(µ2-4,4′-bipyridine)-hexa-copper) (DUT-23-Cu).

In certain aspects, the usable methane storage capacity is greater than or equal to about 216 cm³(STP)/cm³.

In certain aspects, the usable methane storage capacity is greater than or equal to about 226 cm³(STP)/cm³.

In certain further aspects, the present disclosure relates to a method of reversibly storing a gas comprising methane. The method comprises contacting the gas comprising methane at a first pressure with a porous metal-organic framework material having one or more sites for reversibly storing methane. The porous metal-organic framework material is selected from the group consisting of: catena-((µ8-5-(3,5-bis(4-carboxyphenyl)phenyl)benzene-1,3-dicarboxylato)-diaqua-di-copper](UMCM-152), catena-(tetrakis(µ6-benzene-1,3,5-tribenzoate)-tris(µ2-4,4′-bipyridine)-hexa-copper) (DUT 23 Cu), catena-[(µ4-Oxo)-tris(µ4-thieno[3,2-b]thiophene-2,5-dicarboxylato)-tetra-zinc] (VEBHUG or IRMOF-20), catena-[bis(dimethylammonium) (µ-triphenylene-2,3,6,7,10,11-hexolato)-vanadium dihydrate] (FUYCIN or V-CAT-5), catena-[(m-oxido)-tris(m-benzene-1,4-dicarboxylato)-tetra-zinc(ii)] (ja074366osi20070816_031204 or IRMOF-3), catena-[hexakis(dimethylammonium) disulfate tris(m2-oxalato)-di-zinc] (XIYYEL), bis(m2-N′-(3-hydroxy-2-oxybenzylidene)-2-hydroxybenzohydrazide)-tetrakis(pyridine)-di-manganese dinitrate methanol solvate (cg500192d_si_003 or porph@MOM-13), catena-(hexakis(m4-Benzene-1,4-dicarboxylato)-bis(m4-oxo)-octa-zinc solvate trihydrate (VUSKAW or MOF-5), catena-(hexakis(m4-Benzene-1,4-dicarboxylato)-bis(m4-oxo)-octa-zinc solvate) (VUSKEA or MOF-5), catena-(tris(m7-2,2′-(Adipoylbis(azanediyl))diterephthalato)-bis(m4-oxo)-octa-zinc chloroform dimethylformamide solvate) (PEVQOY or IRMOF-3-AM4XL), catena-(tris(m4-Benzene-1,4-dicarboxylato)-(m4-oxo)-tetra-zinc heptakis(N,N-diethylformamide) trihydrate clathrate) (EDUSIF or MOF-5), and combinations thereof. The contacting occurs where a first pressure is greater than or equal to about 65 bar for adsorbing methane molecules on the one or more sites.

In certain aspects, the porous metal-organic framework material is selected from the group consisting of: catena-[bis(dimethylammonium) (µ-triphenylene-2,3,6,7,10,11-hexolato)-vanadium dihydrate] (FUYCIN or V-CAT-5), catena-[(µ4-Oxo)-tris(µ4-thieno[3,2-b]thiophene-2,5-dicarboxylato)-tetra-zinc] (VEBHUG or IRMOF-20), and combinations thereof.

In certain aspects, the porous metal-organic framework material is selected from the group consisting of: catena-((µ8-5-(3,5-bis(4-carboxyphenyl)phenyl)benzene-1,3-dicarboxylato)-diaqua-di-copper] (UMCM-152), catena-(tetrakis(µ6-benzene-1,3,5-tribenzoate)-tris(µ2-4,4′-bipyridine)-hexa-copper) (DUT 23 Cu), catena-[(µ4-Oxo)-tris(µ4-thieno[3,2-b]thiophene-2,5-dicarboxylato)-tetra-zinc] (VEBHUG or IRMOF-20), catena-[bis(dimethylammonium) (µ-triphenylene-2,3,6,7,10,11-hexolato)-vanadium dihydrate] (FUYCIN or V-CAT-5), catena-[(m-oxido)-tris(m-benzene-1,4-dicarboxylato)-tetra-zinc(ii)] (ja074366osi20070816_031204 or IRMOF-3), catena-[hexakis(dimethylammonium) disulfate tris(m2-oxalato)-di-zinc] (XIYYEL), bis(m2-N′-(3-hydroxy-2-oxybenzylidene)-2-hydroxybenzohydrazide)-tetrakis(pyridine)-di-manganese dinitrate methanol solvate (cg500192d_si_003 or porph@MOM-13), catena-(hexakis(m4-Benzene-1,4-dicarboxylato)-bis(m4-oxo)-octa-zinc solvate trihydrate (VUSKAW or MOF-5), catena-(hexakis(m4-Benzene-1,4-dicarboxylato)-bis(m4-oxo)-octa-zinc solvate) (VUSKEA or MOF-5), catena-(tris(m7-2,2′-(Adipoylbis(azanediyl))diterephthalato)-bis(m4-oxo)-octa-zinc chloroform dimethylformamide solvate) (PEVQOY or IRMOF-3-AM4XL), catena-(tris(m4-Benzene-1,4-dicarboxylato)-(m4-oxo)-tetra-zinc heptakis(N,N-diethylformamide) trihydrate clathrate) (EDUSIF or MOF-5), and combinations thereof.

In certain aspects, the porous metal-organic framework material is selected from the group consisting of: catena-((µ8-5-(3,5-bis(4-carboxyphenyl)phenyl)benzene-1,3-dicarboxylato)-diaqua-di-copper](UMCM-152), catena-(tetrakis(µ6-benzene-1,3,5-tribenzoate)-tris(µ2-4,4′-bipyridine)-hexa-copper) (DUT-23-Cu), catena-[(µ₄-Oxo)-tris(µ₄-thieno[3,2-b]thiophene-2,5-dicarboxylato)-tetra-zinc] (VEBHUG or IRMOF-20), catena-[bis(dimethylammonium) (µ-triphenylene-2,3,6,7,10,11-hexolato)-vanadium dihydrate] (FUYCIN or V-CAT-5), catena-[(m-oxido)-tris(m-benzene-1,4-dicarboxylato)-tetra-zinc(ii)] (ja074366osi20070816_031204 or IRMOF-3), catena-[hexakis(dimethylammonium) disulfate tris(m2-oxalato)-di-zinc] (XIYYEL), catena-(hexakis(m4-Benzene-1,4-dicarboxylato)-bis(m4-oxo)-octa-zinc solvate) (VUSKEA or MOF-5), catena-(tris(m7-2,2′-(Adipoylbis(azanediyl))diterephthalato)-bis(m4-oxo)-octa-zinc chloroform dimethylformamide solvate) (PEVQOY or IRMOF-3-AM4XL), and combinations thereof.

In certain aspects, the porous metal-organic framework material is selected from the group consisting of: catena-((µ8-5-(3,5-bis(4-carboxyphenyl)phenyl)benzene-1,3-dicarboxylato)-diaqua-di-copper] (UMCM-152), catena-(tetrakis(µ6-benzene-1,3,5-tribenzoate)-tris(µ2-4,4′-bipyridine)-hexa-copper) (DUT 23 Cu), and combinations thereof.

In certain aspects, the contacting occurs at the first pressure of greater than or equal to about 80 bar.

In certain aspects, the method further comprises releasing the gas comprising methane by desorption from the porous metal-organic framework material by reducing to a second pressure of less than or equal to about 5 bar.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1B show usable volumetric capacity of coordinatively unsaturated sites (CUS) and non-CUS metal-organic frameworks (MOFs) as a function of gravimetric capacity at 298 K under pressure swing between 5 and 65 bar shown in FIGS. 1A and 5 and 80 bar shown in FIG. 1B.

FIGS. 2A-2C show crystal structures of select MOFs prepared in accordance with certain aspects of the present disclosure and assessed for methane uptake. FIG. 2A shows UTSA-76, FIG. 2B shows UMCM-152, and FIG. 2C shows DUT-23-Cu.

FIG. 3 shows a reaction scheme for forming a ligand (organic linker) (H₄L2) for UTSA-76.

FIGS. 4A-4B show reaction schemes for forming a UMCM-152 MOF. FIG. 4A shows a reaction scheme for forming a ligand (organic linker) (H₄L1) for UMCM-152. FIG. 4B shows overall UMCM-152 MOF synthesis.

FIGS. 5A-5B show high pressure CH₄ isotherms. FIG. 5A shows a measured total methane volumetric capacity and FIG. 5B shows gravimetric plots for UTSA-76, UMCM-152 and DUT-23-Cu MOFs. For comparison, an isotherm of HKUST-1 is also shown.

FIGS. 6A-6B show a comparison of measured usable methane capacities of top performing MOFs, HKUST-1, UTSA-76, DUT-23-Cu and UMCM-152 on a volumetric basis (FIG. 6A) and gravimetric basis (FIG. 6B). Capacities are reported under a pressure swing of 80-5 bar at 298 K.

FIG. 7 shows a chart of volumetric methane uptake (cm³ (STP)/cm³ versus pressure (bar) diagram demonstrating principles of usuable methane capacity for a metal-organic framework.

FIG. 8 shows a reaction scheme for forming a DUT-23-Cu MOF in accordance with certain aspects of the present disclosure.

FIG. 9 shows a nitrogen adsorption-desorption isotherm at 77 K and 1 atm pressure of UMCM-152 MOF. The BET surface area was determined to be 3430 ± 30 m²/g (0.02<P/P₀<0.05).

FIG. 10 shows a nitrogen adsorption-desorption isotherm at 77 K and 1 atm pressure of DUT-23-Cu prepared in accordance with certain aspects of the present disclosure. The BET surface area was determined to be 5,300 ± 50 m²/g (0.06<P/P₀<0.08).

FIG. 11 shows an experimental demonstration of methane adsorption isotherm of DUT-23-Cu MOF with methane uptake (cm³ (STP)/cm³) versus pressure (bar) prepared in accordance with certain aspects of the present disclosure.

FIG. 12 shows an experimental demonstration of methane adsorption isotherm of UMCM-152 MOF with methane uptake (cm³ (STP)/cm³) versus pressure (bar) prepared in accordance with certain aspects of the present disclosure.

FIGS. 13A-13F show usable various properties for coordinatively unsaturated sites (CUS) and non-CUS metal-organic frameworks (MOFs). FIG. 13A shows usable volumetric methane capacity (cm³ (STP) cm⁻³) versus gravimetric surface area (m²/g), FIG. 13B shows usable volumetric methane capacity (cm³ (STP) cm⁻³) versus pore volume (cm³/g), FIG. 13C shows usable volumetric methane capacity (cm³ (STP) cm⁻³) versus pore diameter (Å), FIG. 13D shows usable volumetric methane capacity (cm³ (STP) cm⁻³) versus volumetric surface area (m²/cm³), FIG. 13E shows usable volumetric methane capacity (cm³ (STP) cm⁻³) versus single crystal density (g/cm³), and FIG. 13F shows usable volumetric methane capacity (cm³ (STP) cm⁻³) versus void fraction.

FIG. 14 shows an example of a natural gas storage system having at least one metal-organic framework (MOF) prepared in accordance with certain aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature’s relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1 %.

In addition, disclosure of ranges includes disclosure of all values and further divided ranges within the entire range, including endpoints and sub-ranges given for the ranges.

As used herein, the term “material” refers broadly to a substance containing at least the preferred chemical constituents, elements, or compounds, but which may also comprise additional elements, compounds, or substances, including trace amounts of impurities, unless otherwise indicated.

The relevant portions of all references and patent literature cited in this application are expressly incorporated herein by reference.

Example embodiments will now be described more fully with reference to the accompanying drawings.

In various aspects, the present disclosure contemplates a gas storage material comprising a metal-organic framework. In particular, a natural gas storage material is provided that comprises a porous metal-organic framework (MOF) material. A metal-organic framework may comprise a plurality of metal clusters and a plurality of multidentate linking ligands that connect adjacent metal clusters. Each metal cluster may include one or more metal ions and at least one open metal site. Advantageously, the metal-organic framework includes one or more sites for storing gas molecules. In this embodiment, the one or more sites include the at least one open metal site. In certain variations, the one or more sites are capable of reversibly storing methane, for example, storing methane in the one or more sites during an adsorption process and releasing methane from the one or more sites during a desorption process. It should be appreciated that in reversibly storing gas, like methane, it is desirable that the storage material releases a practical volume of methane molecules during desorption at regular operating conditions, although the entirety of the volume of adsorbed molecules may not be fully released and some may remain in the adsorbed state associated with the one or more metal sites (which may be released and desorbed at different conditions).

Generally, natural gas storage materials have a usable storage capacity represented by a methane storage capacity (as methane is the predominant component of natural gas). A methane storage capacity may be defined by the pressure swing conditions for adsorption and desorption. In certain variations, as will be described herein, the MOF natural gas storage material has a methane storage capacity of greater than or equal to about 208 cm³(STP)/cm³ under pressure swing conditions of 80 bar adsorption to 5 bar desorption at 298 K.

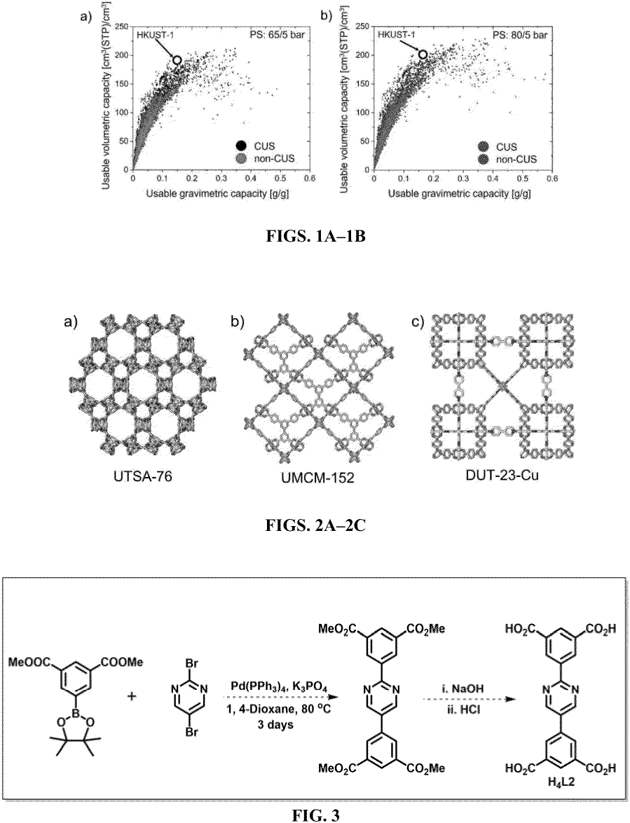

By way of background, as noted above, tens of thousands of MOFs have been synthesized and millions of MOFs are possible, but are yet to be synthesized in the laboratory. Of the tens of thousands of synthesized MOFs, only a fraction has been examined experimentally as potential methane/NG sorbents. It is time consuming and laborious to fabricate MOFs and test their ability to adsorb and desorb methane/NG in a laboratory setting. Thus, it would be advantageous to identify particularly useful MOFs having high methane storage capacity without requiring synthesis and testing. In certain aspects of the present disclosure, computational screening is employed as a tool for identifying optimal MOFs for ANG. For example, high-throughput Grand Canonical Monte Carlo (GCMC) simulations are used to identify promising MOFs for methane storage. As will be discussed further herein, as validation, some of the MOFs identified through this computational screening are synthesized and methane uptake measurements reveal that three of these MOFs - UTSA-76, UMCM-152 and DUT-23-Cu -surpass the methane capacity of HKUST-1 and provide superior natural gas/methane storage materials. Very recently, MFU-41-Li was demonstrated to surpass HKUST-1 at 5-100 bar at 296 K. For initial data, FIG. 1A shows the predicted usable methane (CH₄) capacities for 11,185 MOFs from the CoRE (2019) database at 298 K calculated using GCMC, as described in Peng, Y., et al. “Methane Storage in Metal-Organic Frameworks: Current Records, Surprise Findings, and Challenges.” J. Am. Chem. Soc., 135, pp. 11887-11894 (2013).

The database includes MOFs with and without coordinatively unsaturated sites (CUS). Initial screening was performed with the DREIDING(MOF)/TraPPE(CH₄) potential for non-CUS MOFs and with a potential that accounts for CH₄-CUS interactions. These data are shown in FIGS. 1A-1B. Subsequently, a portion of this data set was reevaluated with an additional set of interatomic potentials: UFF(MOF)/TraPPE(CH₄) for non-CUS MOFs and UFF(MOF)/9-site(CH₄) for CUS MOFs. These potentials yielded superior agreement with the isotherms measured for the MOFs examined in certain aspects of the present disclosure.

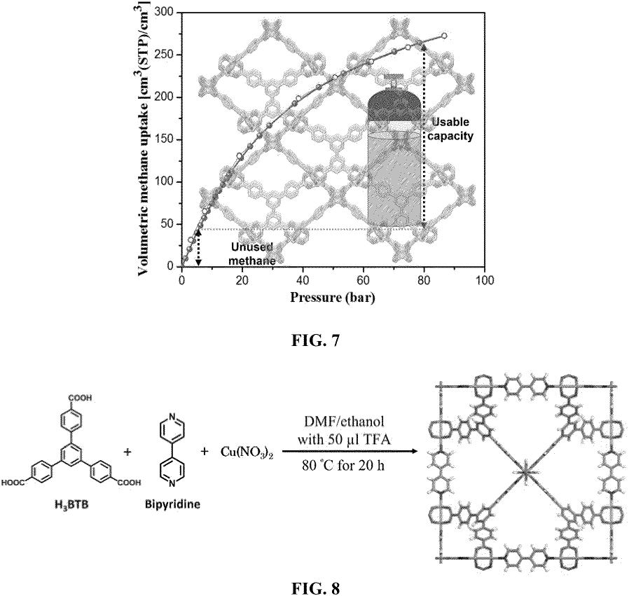

The concept of usable methane capacity is shown in FIG. 7, where volumetric methane uptake (cm³ (STP)/cm³) versus pressure (bar) shows the usuable capacity of a storage material is greater than 5 bar to less than 65 bar or alternatively 80 bar for a given isotherm of a metal-organic framework. As described herein, typically low pressure methane (e.g., released below 5 bar) does not contribute meaningfully to fuel delivered from a storage vessel or tank.

Table 1 shows calculated data using the latter choice of interatomic potentials, namely usuable CH₄ capacities and crystallographic properties of high-capacity MOFs.

TABLE 1

| MOF | Gravimetric surface area (m² g⁻¹) | Pore volume (cm³ g⁻¹) | Pressure swing 65 → 5 bar, 298K | | Pressure swing 80 → 5 bar, 298K | |
|---|---|---|---|---|---|---|
| | | | Gravimetric capacity (g g⁻¹) | Volumetric capacity (cm³ (STP) cm⁻³) | Gravimetric capacity (g g⁻¹ ) | Volumetric capacity (cm³ (STP) cm⁻³) |
| | Expt./Calc. | Expt./Calc. | Expt./Calc. | Expt./Calc. | Expt./Calc. | Expt./Calc. |
| HKUST-1^{a} | 1850/2159 | 0.78/0.81 | 0.154/0.150 | 190/184 | 0.162/0.158 | 200/195 |
| UTSA-76 (Example) | 2700/3205 | 1.09/1.08 | 0.200/0.194 | 195/189 | 0.215/0.207 | 210/201 |
| UMCM-152 (Example) | 3430/3480 | 1.45/1.38 | 0.247/0.259 | 207/205 | 0.271/0.276 | 226/219 |
| DUT-23-Cu (Example) | 5300/4636 | 2.23/1.99 | 0.332/0.333 | 190/192 | 0.377/0.361 | 216/208 |

^{a}Usable capacities of HKUST-1 under 65/5 and 80/5 bar pressure swing were collected from the Peng et al. reference and Mason, J., et al., “Evaluating metal-organic frameworks for natural gas storage,” Chem. Sci., 5, pp. 32-51 (2014). Measured crystallographic properties of HKUST-1 were collected from the Peng et al. reference.

Calculation of crystallographic properties of MOFs is conducted in accordance with certain aspects of the present disclosure as follows. The crystallographic properties of all MOFs were calculated using the Zeo++ code, which employs Voronoi tessellation techniques to evaluate properties related to MOF porosity. A nitrogen molecule with kinetic diameter of 3.72 Å was used as a probe to calculate the surface area per unit mass (gravimetric surface area: gsa) and per unit volume (volumetric surface area: vsa), the largest cavity diameter (lcd), and pore limiting diameter (pld).

Grand Canonical Monte Carlo (GCMC) calculations. The CH₄ capacities of MOFs were computed using GCMC as implemented in the RASPA code. CH₄ adsorption was calculated at 298 K for pressures of 5, 65, and 80 bar. For selected MOFs, full isotherms were evaluated. CH₄ capacity at a given temperature and pressure was evaluated by averaging the number of CH₄ molecules in the simulation cell over multiple GCMC cycles. At each cycle, translation, insertion and deletion of CH₄ molecules were performed with equal probabilities. For CUS MOFs using the quantum-mechanically tuned MOMs potential,9 and for MOFs without CUS, CH₄ isotherm data was collected from 3,000 production cycles, preceded by 2,000 initialization cycles. For CUS MOFs where the UFF(MOF)/9-site(CH₄) potential was used, electrostatic interactions between MOF and CH₄ molecules were accounted for using an Ewald summation; charges on the MOF atoms were calculated using the “charge equilibration” (Qeq) method. In this case, CH₄ adsorption isotherm data was collected from 6,000 production cycles, preceded by 4,000 initialization cycles. All MOFs were treated as rigid frameworks during CH₄ uptake calculations.

Computational screening. 11,185 previously synthesized MOFs were screened from the CoRE18 (2019) database using GCMC calculations. Among these MOFs, 7,351 contain CUS, and 3,834 are non-CUS MOFs. Screening results based on the MOMs (Michigan Open Metal Site) potential for the CUS MOFs are presented in FIG. 1 and in Tables 2 and 3. FIG. 1 and Tables 2 and 3 present similar results for the non-CUS MOFs as calculated with the DREIDING(MOF)/TraPPE(CH₄) interatomic potential. Subsequently, a sub-set of this data set was reevaluated with an additional set of interatomic potentials: UFF(MOF)/TraPPE(CH₄) for non-CUS MOFs and the UFF(MOF)/9-site(CH₄) for CUS MOFs. This choice of potentials yielded superior agreement with the isotherms measured for the MOFs examined here (Table 1).

Two isothermal “pressure swing” operating conditions at 298 K are considered: a swing between 65 and 5 bar, and between 80 and 5 bar. From these calculations, 95 CUS MOFs are predicted to surpass both usable volumetric and gravimetric CH₄ capacities of HKUST-1 (190 cm³ (STP) cm⁻³ & 0.154 g g⁻¹) for a pressure swing between 65 and 5 bar, while 96 CUS MOFs outperform HKUST-1 (200 cm³ (STP) cm³ & 0.162 g g⁻¹) for a pressure swing of 80 to 5 bar, as reflected in Tables 1 and 2.

Table 2 shows usable capacities (pressure swing between 65 and 5 bar) and crystallographic properties of the top 50 CUS MOFs. Screening was conducted based on the MOMs interatomic potential.

TABLE 2

| MOF Name | Source | Density (g/cm³) | Gravimetric surface area (m²/g) | Volumetric surface area (m²/cm³) | Void fraction | Pore volume (cm³/g) | Largest cavity diameter (Å) | Pore limiting diameter (Å) | Usable gravimetric capacity (g/g) | Usable volumetric capacity (cm³ STP/cm³) |
|---|---|---|---|---|---|---|---|---|---|---|
| HKUST-1 | | | | | | | | | 0.154 | 190 |
| NAFSOF | CoRE (2019) | 0.44 | 5220 | 2285 | 0.82 | 1.9 | 10.4 | 8.3 | 0.358 | 219 |
| RICBEM | CoRE (2019) | 0.40 | 5705 | 2277 | 0.82 | 2.1 | 11.4 | 8.6 | 0.385 | 215 |
| RAYMIP | CoRE (2019) | 0.50 | 4196 | 2110 | 0.81 | 1.6 | 13.5 | 9.8 | 0.305 | 214 |
| MIXZOK | CoRE (2019) | 0.45 | 4658 | 2109 | 0.81 | 1.8 | 13.2 | 9.8 | 0.339 | 214 |
| BICPUA | CoRE (2019) | 0.54 | 3872 | 2106 | 0.82 | 1.5 | 13.8 | 9.9 | 0.281 | 214 |
| HAVZIP | CoRE (2019) | 0.42 | 4690 | 1955 | 0.82 | 2.0 | 13.0 | 9.6 | 0.366 | 213 |
| ZAHLEC | CoRE (2019) | 0.50 | 5357 | 2701 | 0.81 | 1.6 | 10.7 | 8.4 | 0.302 | 213 |
| ic800131r -file003 | CoRE (2019) | 0.42 | 4750 | 1983 | 0.82 | 2.0 | 12.9 | 9.6 | 0.364 | 212 |
| IDEYOF | CoRE (2019) | 0.43 | 5779 | 2478 | 0.81 | 1.9 | 10.0 | 6.2 | 0.355 | 212 |
| RAYMOV | CoRE (2019) | 0.42 | 4982 | 2113 | 0.81 | 1.9 | 13.9 | 9.7 | 0.357 | 211 |
| MAHCEG | CoRE (2019) | 0.53 | 4046 | 2149 | 0.81 | 1.5 | 18.5 | 8.0 | 0.285 | 211 |
| BEWCUD | CoRE (2019) | 0.48 | 4457 | 2124 | 0.82 | 1.7 | 11.4 | 9.6 | 0.317 | 211 |
| FISGOF | CoRE (2019) | 0.43 | 4624 | 2007 | 0.84 | 1.9 | 15.8 | 8.6 | 0.348 | 211 |
| XOVPUU | CoRE (2019) | 0.40 | 4969 | 2012 | 0.84 | 2.1 | 11.5 | 9.8 | 0.370 | 209 |
| TOVJAR | CoRE (2019) | 0.52 | 4005 | 2068 | 0.81 | 1.6 | 12.4 | 8.5 | 0.289 | 208 |
| JOGSAA | CoRE (2019) | 0.42 | 4728 | 1990 | 0.82 | 2.0 | 13.0 | 9.4 | 0.354 | 208 |
| BAZFUF | CoRE (2019) | 0.34 | 5368 | 1825 | 0.86 | 2.5 | 20.2 | 8.6 | 0.437 | 208 |
| XEBHOC | CoRE (2019) | 0.47 | 4693 | 2182 | 0.81 | 1.7 | 12.1 | 9.9 | 0.320 | 208 |
| TOVJIZ | CoRE (2019) | 0.45 | 4504 | 2032 | 0.80 | 1.8 | 12.7 | 8.3 | 0.329 | 207 |
| BAZFUF01 | CoRE (2019) | 0.34 | 5354 | 1831 | 0.86 | 2.5 | 20.1 | 8.5 | 0.432 | 207 |
| XAWVUN | CoRE (2019) | 0.46 | 4721 | 2192 | 0.81 | 1.7 | 10.8 | 9.2 | 0.317 | 206 |
| ZIJSAO | CoRE (2019) | 0.47 | 4735 | 2204 | 0.81 | 1.7 | 20.3 | 7.5 | 0.316 | 206 |
| POHWIU | CoRE (2019) | 0.46 | 4230 | 1949 | 0.81 | 1.8 | 15.9 | 10.4 | 0.319 | 206 |
| LURRIA | CoRE (2019) | 0.41 | 4611 | 1874 | 0.83 | 2.1 | 22.4 | 9.7 | 0.362 | 206 |
| VOLRAQ01 | CoRE (2019) | 0.56 | 3315 | 1861 | 0.84 | 1.5 | 16.9 | 11.2 | 0.262 | 205 |
| ANUGIA | CoRE (2019) | 0.57 | 4061 | 2306 | 0.79 | 1.4 | 13.9 | 6.8 | 0.258 | 205 |
| SETTAO | CoRE (2019) | 0.53 | 3851 | 2057 | 0.79 | 1.5 | 13.9 | 10.0 | 0.274 | 205 |
| ANUGOG | CoRE (2019) | 0.58 | 4228 | 2472 | 0.79 | 1.4 | 11.4 | 7.1 | 0.249 | 204 |
| XAFFER | CoRE (2019) | 0.36 | 5153 | 1854 | 0.85 | 2.4 | 14.2 | 13.3 | 0.405 | 203 |
| FATQID | CoRE (2019) | 0.61 | 3634 | 2205 | 0.80 | 1.3 | 11.5 | 8.6 | 0.240 | 203 |
| TOVJEV | CoRE (2019) | 0.40 | 4737 | 1893 | 0.84 | 2.1 | 13.7 | 10.4 | 0.364 | 203 |
| XAFFAN | CoRE (2019) | 0.37 | 5192 | 1896 | 0.85 | 2.3 | 14.9 | 13.2 | 0.398 | 203 |
| ENIHUG01 | CoRE (2019) | 0.59 | 3971 | 2323 | 0.77 | 1.3 | 13.8 | 6.8 | 0.248 | 203 |
| WAVQOB | CoRE (2019) | 0.66 | 2985 | 1981 | 0.77 | 1.2 | 10.3 | 8.2 | 0.219 | 203 |
| EFAYIU | CoRE (2019) | 0.43 | 5192 | 2251 | 0.82 | 1.9 | 11.6 | 8.6 | 0.335 | 203 |
| CAVPUM | CoRE (2019) | 0.41 | 4768 | 1943 | 0.82 | 2.0 | 20.4 | 7.8 | 0.356 | 202 |
| VAGMAT | CoRE (2019) | 0.36 | 5141 | 1875 | 0.86 | 2.4 | 14.9 | 13.3 | 0.397 | 202 |
| NAYZOE | CoRE (2019) | 0.50 | 4615 | 2302 | 0.81 | 1.6 | 15.8 | 6.5 | 0.290 | 202 |
| ATEYED | CoRE (2019) | 0.47 | 7061 | 3303 | 0.78 | 1.7 | 7.5 | 6.2 | 0.309 | 202 |
| MINCUJ | CoRE (2019) | 0.69 | 2920 | 2024 | 0.76 | 1.1 | 12.0 | 7.6 | 0.208 | 202 |
| VAGMEX | CoRE (2019) | 0.35 | 5189 | 1828 | 0.86 | 2.5 | 15.3 | 14.5 | 0.410 | 202 |
| ANUGEW | CoRE (2019) | 0.44 | 4709 | 2088 | 0.83 | 1.9 | 14.4 | 10.2 | 0.325 | 201 |
| ACUFEK | CoRE (2019) | 0.56 | 3942 | 2205 | 0.79 | 1.4 | 15.6 | 9.0 | 0.258 | 201 |
| ENIHUG | CoRE (2019) | 0.58 | 4025 | 2341 | 0.79 | 1.4 | 13.8 | 6.8 | 0.247 | 201 |
| ASIVAB | CoRE (2019) | 0.54 | 4325 | 2328 | 0.80 | 1.5 | 12.3 | 7.3 | 0.267 | 201 |
| DICKEH | CoRE (2019) | 0.52 | 4507 | 2355 | 0.80 | 1.5 | 12.8 | 7.4 | 0.274 | 200 |
| YIPDOR | CoRE (2019) | 0.45 | 5445 | 2441 | 0.80 | 1.8 | 10.3 | 7.5 | 0.318 | 199 |
| XAFFOB | CoRE (2019) | 0.37 | 5119 | 1879 | 0.85 | 2.3 | 14.8 | 13.2 | 0.389 | 199 |
| RUVKAV | CoRE (2019) | 0.60 | 3706 | 2230 | 0.78 | 1.3 | 12.0 | 7.2 | 0.236 | 199 |
| VANNIK | CoRE (2019) | 0.49 | 3703 | 1808 | 0.85 | 1.7 | 12.1 | 10.7 | 0.291 | 199 |

Table 3 shows usable capacities (pressure swing between 80 and 5 bar) and crystallographic properties of the top 50 CUS MOFs. Screening was conducted based on the MOMs interatomic potential.

TABLE 3

| MOF Name | Source | Density (g/cm³) | Gravimetric surface area (m²/g) | Volumetric surface area (m2/cm³) | Void fraction | Pore volume (cm3/g) | Largest cavity diameter (Å) | Pore limiting diameter (Å) | Usable gravimetric capacity (g/g) | Usable volumetric capacity (cm³ STP/ cm³) |
|---|---|---|---|---|---|---|---|---|---|---|
| HKUST-1 | | | | | | | | | 0.162 | 200 |
| NAFSOF | CoRE (2019) | 0.44 | 5220 | 2285 | 0.82 | 1.9 | 10.4 | 8.3 | 0.380 | 232 |
| RICBEM | CoRE (2019) | 0.40 | 5705 | 2277 | 0.82 | 2.1 | 11.4 | 8.6 | 0.414 | 231 |
| BAZFUF | CoRE (2019) | 0.34 | 5368 | 1825 | 0.86 | 2.5 | 20.2 | 8.6 | 0.482 | 229 |
| BAZFUF01 | CoRE (2019) | 0.34 | 5354 | 1831 | 0.86 | 2.5 | 20.1 | 8.5 | 0.477 | 228 |
| HAVZIP | CoRE (2019) | 0.42 | 4690 | 1955 | 0.82 | 2.0 | 13.0 | 9.6 | 0.391 | 228 |
| BICPUA | CoRE (2019) | 0.54 | 3872 | 2106 | 0.82 | 1.5 | 13.8 | 9.9 | 0.300 | 228 |
| FISGOF | CoRE (2019) | 0.43 | 4624 | 2007 | 0.84 | 1.9 | 15.8 | 8.6 | 0.375 | 227 |
| RAYMOV | CoRE (2019) | 0.42 | 4982 | 2113 | 0.81 | 1.9 | 13.9 | 9.7 | 0.383 | 227 |
| MIXZOK | CoRE (2019) | 0.45 | 4658 | 2109 | 0.81 | 1.8 | 13.2 | 9.8 | 0.359 | 227 |
| ic800131r-file003 | CoRE (2019) | 0.42 | 4750 | 1983 | 0.82 | 2.0 | 12.9 | 9.6 | 0.389 | 227 |
| IDEYOF | CoRE (2019) | 0.43 | 5779 | 2478 | 0.81 | 1.9 | 10.0 | 6.2 | 0.378 | 226 |
| XOVPUU | CoRE (2019) | 0.40 | 4969 | 2012 | 0.84 | 2.1 | 11.5 | 9.8 | 0.400 | 226 |
| VOLRAQ01 | CoRE (2019) | 0.56 | 3315 | 1861 | 0.84 | 1.5 | 16.9 | 11.2 | 0.288 | 226 |
| RAYMIP | CoRE (2019) | 0.50 | 4196 | 2110 | 0.81 | 1.6 | 13.5 | 9.8 | 0.322 | 226 |
| BEWCUD | CoRE (2019) | 0.48 | 4457 | 2124 | 0.82 | 1.7 | 11.4 | 9.6 | 0.338 | 225 |
| ZAHLEC | CoRE (2019) | 0.50 | 5357 | 2701 | 0.81 | 1.6 | 10.7 | 8.4 | 0.319 | 225 |
| JOGSAA | CoRE (2019) | 0.42 | 4728 | 1990 | 0.82 | 2.0 | 13.0 | 9.4 | 0.382 | 225 |
| MAHCEG | CoRE (2019) | 0.53 | 4046 | 2149 | 0.81 | 1.5 | 18.5 | 8.0 | 0.302 | 224 |
| TOVJAR | CoRE (2019) | 0.52 | 4005 | 2068 | 0.81 | 1.6 | 12.4 | 8.5 | 0.310 | 224 |
| LURRIA | CoRE (2019) | 0.41 | 4611 | 1874 | 0.83 | 2.1 | 22.4 | 9.7 | 0.392 | 223 |
| TOVJEV | CoRE (2019) | 0.40 | 4737 | 1893 | 0.84 | 2.1 | 13.7 | 10.4 | 0.397 | 221 |
| XEBHOC | CoRE (2019) | 0.47 | 4693 | 2182 | 0.81 | 1.7 | 12.1 | 9.9 | 0.341 | 221 |
| POHWIU | CoRE (2019) | 0.46 | 4230 | 1949 | 0.81 | 1.8 | 15.9 | 10.4 | 0.343 | 221 |
| TOVJIZ | CoRE (2019) | 0.45 | 4504 | 2032 | 0.80 | 1.8 | 12.7 | 8.3 | 0.350 | 221 |
| XAFFER | CoRE (2019) | 0.36 | 5153 | 1854 | 0.85 | 2.4 | 14.2 | 13.3 | 0.439 | 221 |
| VAGMAT | CoRE (2019) | 0.36 | 5141 | 1875 | 0.86 | 2.4 | 14.9 | 13.3 | 0.433 | 220 |
| XAWVUN | CoRE (2019) | 0.46 | 4721 | 2192 | 0.81 | 1.7 | 10.8 | 9.2 | 0.340 | 220 |
| XAFFAN | CoRE (2019) | 0.37 | 5192 | 1896 | 0.85 | 2.3 | 14.9 | 13.2 | 0.432 | 220 |
| ZIJSAO | CoRE (2019) | 0.47 | 4735 | 2204 | 0.81 | 1.7 | 20.3 | 7.5 | 0.338 | 220 |
| VANNIK | CoRE (2019) | 0.49 | 3703 | 1808 | 0.85 | 1.7 | 12.1 | 10.7 | 0.322 | 220 |
| ANUGEW | CoRE (2019) | 0.44 | 4709 | 2088 | 0.83 | 1.9 | 14.4 | 10.2 | 0.354 | 219 |
| VAGMEX | CoRE (2019) | 0.35 | 5189 | 1828 | 0.86 | 2.5 | 15.3 | 14.5 | 0.446 | 219 |
| FIFGEI | CoRE (2019) | 0.41 | 4211 | 1738 | 0.86 | 2.1 | 16.2 | 14.7 | 0.380 | 219 |
| CAVPUM | CoRE (2019) | 0.41 | 4768 | 1943 | 0.82 | 2.0 | 20.4 | 7.8 | 0.385 | 219 |
| SETTAO | CoRE (2019) | 0.53 | 3851 | 2057 | 0.79 | 1.5 | 13.9 | 10.0 | 0.292 | 218 |
| EFAYIU | CoRE (2019) | 0.43 | 5192 | 2251 | 0.82 | 1.9 | 11.6 | 8.6 | 0.359 | 217 |
| ANUGIA | CoRE (2019) | 0.57 | 4061 | 2306 | 0.79 | 1.4 | 13.9 | 6.8 | 0.273 | 217 |
| XAFFOB | CoRE (2019) | 0.37 | 5119 | 1879 | 0.85 | 2.3 | 14.8 | 13.2 | 0.423 | 217 |
| FATQID | CoRE (2019) | 0.61 | 3634 | 2205 | 0.80 | 1.3 | 11.5 | 8.6 | 0.256 | 217 |
| XAFFIV | CoRE (2019) | 0.36 | 5300 | 1899 | 0.85 | 2.4 | 14.2 | 13.2 | 0.431 | 216 |
| ANUGOG | CoRE (2019) | 0.58 | 4228 | 2472 | 0.79 | 1.4 | 11.4 | 7.1 | 0.263 | 215 |
| NAYZOE | CoRE (2019) | 0.50 | 4615 | 2302 | 0.81 | 1.6 | 15.8 | 6.5 | 0.309 | 215 |
| DICKEH | CoRE (2019) | 0.52 | 4507 | 2355 | 0.80 | 1.5 | 12.8 | 7.4 | 0.294 | 214 |
| XAHPED | CoRE (2019) | 0.37 | 5199 | 1947 | 0.84 | 2.2 | 12.4 | 10.9 | 0.409 | 214 |
| ASIVAB | CoRE (2019) | 0.54 | 4325 | 2328 | 0.80 | 1.5 | 12.3 | 7.3 | 0.284 | 214 |
| WAVQOB | CoRE (2019) | 0.66 | 2985 | 1981 | 0.77 | 1.2 | 10.3 | 8.2 | 0.230 | 214 |
| MINCUJ | CoRE (2019) | 0.69 | 2920 | 2024 | 0.76 | 1.1 | 12.0 | 7.6 | 0.221 | 213 |
| UDANIY | CoRE (2019) | 0.42 | 4181 | 1745 | 0.85 | 2.0 | 23.9 | 23.5 | 0.366 | 213 |
| ATEYED | CoRE (2019) | 0.47 | 7061 | 3303 | 0.78 | 1.7 | 7.5 | 6.2 | 0.325 | 213 |
| cg500175k_si_001 | CoRE (2019) | 0.52 | 3653 | 1882 | 0.82 | 1.6 | 20.4 | 9.9 | 0.295 | 213 |

As referred to herein, Table 4 provides a cross-reference of select MOF names and chemistry used herein. Further, as will be described below, each of the MOFs listed in Table 4 has a better usable methane storage capacity for methane/natural gas storage than the benchmark of HKUST-1 at pressure swing conditions of 65 bar adsorption to 5 bar desorption and at 80 bar adsorption to 5 bar desorptionat 298 K.

TABLE 4

| | | | |
|---|---|---|---|
| IUPAC Name | MOF Category | Chemical/Common name of MOF | Abbreviation (Called MOFs_Refcode) |
| catena-[(µ4-Oxo)-tris(µ4-thieno[3,2-b]thiophene-2,5-dicarboxylato)-tetra-zinc] | Non-CUS-MOF | IRMOF-20 | VEBHUG or a074366_SL |
| catena-[bis(dimethylammonium) (µ-triphenylene-2,3,6,7,10,11-hexolato)-vanadium dihydrate] | CUS-MOF | V-CAT-5 | FUYCIN |
| catena-[(m-oxido)-tris(m-benzene-1,4-dicarboxylato)-tetra-zinc(ii)] | Non-CUS-MOF | IRMOF-3 | ja074366osi20070816 _031204 |
| catena-[hexakis(dimethylammonium) disulfate tris(m2-oxalato)-di-zinc] | CUS-MOF | no name, compound 1 in paper | XIYYEL |
| bis(m2-N′-(3-hydroxy-2-oxybenzylidene)-2-hydroxybenzohydrazide)-tetrakis(pyridine)-di-manganese dinitrate methanol solvate | Non-CUS-MOF | porph@MOM-13 | cg500192d_si_003 |
| catena-(hexakis(m4-Benzene-1,4-dicarboxylato)-bis(m4-oxo)-octa-zinc solvate trihydrate) | Non-CUS-MOF | MOF-5 | VUSKAW |
| catena-(hexakis(m4-Benzene-1,4-dicarboxylato)-bis(m4-oxo)-octa-zinc solvate) | Non-CUS-MOF | MOF-5 | VUSKEA |
| catena-(tris(m7-2,2′-(Adipoylbis(azanediyl))diterephthalato)-bis(m4-oxo)-octa-zinc chloroform dimethylformamide solvate) | Non-CUS-MOF | IRMOF-3-AM4XL | PEVQOY |
| catena-(tris(m4-Benzene-1,4-dicarboxylato)-(m4-oxo)-tetra-zinc heptakis(N,N-diethylformamide) trihydrate clathrate) | Non-CUS-MOF | MOF-5 | EDUSIF |
| catena-((µ8-Biphenyl-3,3′,5,5′-tetrakis(4-carboxylatophenyl))-diaqua-di-copper) | CUS-MOF | UTSA-68 | NAFSOF |
| catena-[(µ8-5′,5″-Anthracene-9,10-diylbis(1,1′:3′,1″-terphenyl-4,4″-dicarboxylato))-di-aqua-di-copper octahydrate] | CUS-MOF | MOF-la | RICBEM |
| catena-[(µ12-1,3,5-tris(3,5-di(4-carboxylatophenyl)phenyl)benzene)-(µ3-oxo)-triaqua-tri-indium(iii)] | CUS-MOF | JUC-101 | RAYMIP |
| catena-(dimethylammonium (µ-1,3,5-tris(3,5-bis(4-carboxyphenyl)phenyl)benzene)-(µ-hydroxo)-triaqua-tri-nickel N,N-dimethylacetamide solvate heptahydrate) | CUS-MOF | JUC-105 | MIXZOK |
| catena-[(µ12-1,3,5-tris(4,4″-Dicarboxylato-1,1′:3′,1″-terphenyl-5′-yl)benzene)-(µ3-oxo)-triaqua-ytterbium(iii)] | CUS-MOF | UTSA-62 | BICPUA |
| catena-(bis(4,4′-bipyridinium) tris(µ2-4,4′-bipyridine)-(µ2-oxalato)-diaqua-di-cobalt bis(µ9-arsenato)-hexatriacontakis(µ2-oxo)-octadecaoxo-octadeca-tungsten dihydrate) | non-CUS-MOF | no name, compound 1 in paper | HAVZIP |
| catena-[tetrakis(µ-3-(4-(1H-imidazol-1-yl)benzoato))-(µ-naphthalene-1,5-disulfonato)-diaqua-tri-copper] | non-CUS-MOF | fsc-1-NDS | ZAHLEC |
| catena-(bis(µ2-4,4′-Bipyridine-N,N′)-bis(dihydrogen phosphato)-nickel(ii) n-butanol solvate monohydrate) | non-CUS-MOF | no name, compound 1 in paper | IDEYOF |
| catena-[(µ₁₂-1,3,5-tris(3,5-di(4-carboxylatophenyl)phenyl)benzene)-(µ₃₋hydroxo)-triaqua-tri-manganese(ii) | CUS-MOF | JUC-102 | RAYMOV |
| catena-[hexakis(µ-10-(4-carboxylatophenyl)-10H-phenoxazine-3,7-dicarboxylato)-bis(µ-oxo)-triaqua-tri-copper-octa-zinc | CUS-MOF | no name, | MAHCEG |
| catena-((µ17-5,10,15,20-tetrakis(3,5-bis(4-carboxylatophenyl)phenyl)porphyrinato)-hexaaqua-penta-zinc N,N-dimethylformamide solvate hexahydrate) | non-CUS MOF | UNLPF-1 | BEWCUD |
| catena-[(µ8-5′-((3,5-dicarboxylatophenyl)ethynyl)-1,1′:3′,1″-terphenyl-4,4″-dicarboxylato)-diaqua-di-copper N,N-diethylformamide solvate hydrate] | CUS MOF | ZJU-32 | FISGOF |
| catena-((µ8-4,4′,4″,4‴-(2,2′-Dihydroxy-1,1′-biphenyl-3,3′,5,5′-tetrayl)tetrabenzoato)-diaqua-di-copper(ii) N,N-dimethylformamide solvate decahydrate) | CUS-MOF | no name, compound 3 in paper | XOVPUU |
| catena-[tetrakis(µ-benzene-1,3,5-tris(4-benzoato))-bis(µ-oxo)-hexa-aqua-hexa-iron unknown solvate] | CUS-MOF | PCN-260 | TOVJAR |
| catena-(tris(µ2-4,4′-Bipyridine)-(µ2-oxalato)-diaqua-di-nickel(ii) bis(µ9-phosphato)-hexatriacontakis(µ2-oxo)-octadecaoxo-octadeca-tungsten bis(4,4′-bipyridinium) clathrate dihydrate) | non-CUS-MOF | no name, compound 2 in paper | JOGSAA |
| catena-(tetrakis(µ6-benzene-1,3,5-tribenzoato)-hexaaqua-hexa-copper) | CUS-MOF | DUT-34 | BAZFUF |
| catena-((µ8-N,N,N′,N′-tetrakis(4-Carboxyphenyl)-1,4-phenylenediamine)-diaqua-di-copper dimethylsulfoxide solvate hexahydrate) | CUS-MOF | no name, compound 1 in paper | XEBHOC |
| catena-[bis(µ-2-hydroxy-benzene-1,3,5-tris(4-benzoato))-(µ-oxo)-triaqua-tri-iron] | CUS-MOF | PCN-262 | TOVJIZ |
| catena-((µ8-rac-D2-N,N,N′,N′-tetrakis(4-Carboxyphenyl)-1,4-phenylenediamine)-diaqua-di-copper dimethylsulfoxide solvate hexahydrate) | CUS-MOF | no name, compound 2 in paper | XAWVUN |
| catena-(tris(Dimethylammonium) bis(µ6-1,3,5-tris(3,5-bis(4-carboxylatophenyl)phenyl)benzene)-triaqua-tri-terbium dimethylacetamide solvate) | CUS-MOF | UTSA-61 | ZIJSAO |
| catena-[(µ17-5,10,15,20-tetrakis(4,4″-dicarboxylato-1,1′:3′,1″-terphenyl-5′-yl)porphyrinato)-(µ2-carbon dioxide)-tetra-aqua-penta-cobalt] | CUS-MOF | UNLPF-2 | POHWIU |
| catena-[(µ12-1,3,5-tris(4-(3,5-Dicarboxylatophenylethynyl)phenyl)benzene)-triaqua-tri-copper(ii) dimethylformamide solvate hexacosahydrate] | CUS-MOF | NOTT-116 | LURRIA |
| catena-((µ8-5-(3,5-bis(4-carboxyphenyl)phenyl)benzene-1,3-dicarboxylato)-diaqua-di-copper] | CUS-MOF | UMCM-152 | ANUGIA |
| catena-[hexakis(µ3-Isonicotinamido)-bis(µ3-4,4′,4″-[1,3,5-benzenetriyltris(carbonylimino)]tribenzoato)-(µ3-oxo)-diaqua-hydroxy-tri-chromium-tri-zinc dimethylformamide solvate | non-CUS-MOF | tp-PMBB-1-asc-1 | SETTAO |
| catena-((µ8-5-(3,5-bis(4-carboxyphenyl)phenyl)benzene-1,3-dicarboxylato)-diaqua-di-copper] | CUS-MOF | UMCM-153 | ANUGOG |
| catena-((µ8-4,4′,4″,4‴-(biphenyl-4,4′-diyldinitrilo)tetrabenzoato)-diaqua-di-zinc] | CUS-MOF | DUT-11 | XAFFER |
| catena-(hexakis(µ4-Benzene-1,4-dicarboxylato)-bis(µ4-oxo)-octa-zinc] | CUS-MOF | UNLPF-4 | FATOID |
| catena-[bis(µ-2-amino-benzene-1,3,5-tris(4-benzoato))-(µ-oxo)-triaqua-tri-ironi | CUS-MOF | PCN-261 | TOVJEV |
| catena-((µ,8 4,4′,4″,4‴-(biphenyl-4,4′-diyldinitrilo)tetrabenzoato)-diaqua-di-zinc] | CUS-MOF | DUT-10(Zn) | XAFFAN |
| catena-((µ-5-(2,6-bis(4-carboxylatophenyl)pyridin-4-yl)isophthalato)-diaqua-di-copper] | CUS-MOF | BUT-20 | ENIHUG01 |
| catena-(tetrakis(µ8-2,2′-Diethoxy-1,1′-biphenyl-3,3′,5,5′-tetrakis(p-phenylenecarboxylato))-octa-aqua-octa-zinc(ii) octatetracontakis(dimethylformamide) clathrate) | CUS-MOF | no name, compound 5 in paper | EFAYIU |
| catena-(tetrakis(µ6-4,4′,4″-Benzene-1,3,5-triyltris(benzoato))-tris(µ2-4,4′-bipyridine)-hexa-zinc dimethylformamide solvate hydrate) | non-CUS-MOF | FJI-1 | CAVPUM |
| catena-((µ8-4,4′,4″,4‴-(Biphenyl-4,4′-diyldinitrilo)tetrabenzoato)-diaqua-di-zinc dimethylformamide solvate hexahydrate) | CUS-MOF | SNU-30 | VAGMAT |
| catena-[tetrakis(µ6-Triphenylamine-4,4′,4″-tricarboxylato)-hexaaqua-hexa-copper methanol solvate octahydrate) | CUS-MOF | Cu-TCA | NAYZOE |
| catena-((2)-(bis(µ2-1,4-bis(Imidazol-1-ylmethyl)benzene)-di-aqua-cobalt(ii))-(bis(µ2-1,4-bis(imidazol-1-ylmethyl)benzene)-di-aqua-cobalt(ii))-catenane bis(sulfate) tetradecahydrate) | non-CUS-MOF | no name, compound 2 in paper | ATEYED |
| catena-[(µ4-triphenylene-2,6,10-tricarboxylato)-aqua-(propan-1-ol)-terbium propan-1-ol solvate) | CUS-MOF | SNU-2 | MINCUJ |
| catena-((µ8-4,4′,4″,4‴-(Biphenyl-4,4′-diyldinitrilo)tetrabenzoato)-diaqua-di-zinc diethylformamide solvate) | CUS-MOF | SNU-30SC | VAGMEX |
| catena-(tetrakis(µ6-1,1′:3′,1″-terphenyl-4,4″,5′-tricarboxylato)-hexaaqua-hexa-copper unknown solvate) | CUS-MOF | UMCM-151 | ANUGEW |
| catena-[octakis(µ6-4,4′,4″-s-Triazine-2,4,6-triyltribenzoato)-dodecaaqua-dodeca-copper dodecakis(dimethylsulfoxide) hydrate clathrate] | CUS-MOF | PCN-6 | ACUFEK |
| catena-[(µ-5-(2,6-bis(4-carboxylatophenyl)pyridin-4-yl)isophthalato)-diaqua-di-copper | CUS-MOF | Cu-BCP | ENIHUG |
| catena-(tetrakis(µ-2′-amino-1, 1′:3′,1″-terphenyl-4,4″,5′-tricarboxylato)-hexa-aqua-hexa-copper dimethylformamide | CUS-MOF | Cu-ATTCA | ASIVAB |
| catena-[(µ8-5,5′-(1,4-Phenylenediethyne-2,1-diyl)diisophthalato)-diaqua-di-copper | CUS-MOF | NJU-BAI-12 | DICKEH |
| catena-([3]-(bis(bis(µ2-4,4′-bis(1,2,4-Triazol-1-yl)biphenyl)-diaqua-copper(ii)) bis(µ2-4,4′-bis(1,2,4-triazol-1-yl)biphenyl)-di-copper(i))-rotaxane α-(µ12-phosphato)-tetracosa(µ2-oxo)-dodecaoxo-molybdenum(v)-undeca-molybdum(vi) clathrate) | non-CUS-MOF | no name, compound 2 in paper | YIPDOR |
| catena-((µ8-4,4′,4″,4‴-(biphenyl-4,4′-divldinitrilo)tetrabenzoato)-diaqua-di-copper | CUS-MOF | DUT-10(Cu) | XAFFOB |
| catena-[(µ8-5,5′-(Butadiyne-1,4-diyl)diisophthalato)-diaqua-di-copper(ii) dimethylformamide solvate trihydrate] | CUS-MOF | MOF-505 | RUVKAV |
| catena-[tetrakis(Dimethylammonium) tris(µ-tetrakis(4-carboxylatophenyl)methane)-octa-oxo-tetra-uranium N,N-dimethylformamide solvate hectahydrate] | CUS-MOF | U-MOF | VANNIK |
| catena-(tetrakis(µ6-benzene-1,3,5-tribenzoate)-tris(µ2-4,4′-bipyridine)-hexa-cobalt) | non-CUS-MOF | DUT-23-Co | ICAQIO |
| catena-(tetrakis(µ6-benzene-1,3,5-tribenzoate)-tris(µ2-4,4′-bipyridine)-hexa-copper) | non-CUS-MOF | DUT-23-Cu | ICAQOU |

By further analysis, a total of about 8 non-CUS MOFs are predicted to surpass HKUST-1, while about 9 are equivalent to HKUST-1′s performance at 85-5 bar pressure swing at 298 K, as reflected in Tables 5 and 6.

Table 5 shows usable capacities (pressure swing between 65 and 5 bar) and crystallographic properties of 50 promising non-CUS MOFs. Screening is conducted based on the DREIDING(MOF)/TraPPE(CH₄) interatomic potential.

TABLE 5

| MOF Name | Source | Density (g/cm³) | Gravimetric surface area (m²/g) | Volumetric surface area (m²/ cm³) | Void fraction | Pore volume (cm³/g) | Largest cavity diameter (Å) | Pore limiting diameter (Å) | Usable gravimetric capacity (g/g) | Usable volu-metric capacity (cm³ STP /cm³) |
|---|---|---|---|---|---|---|---|---|---|---|
| HKUST-1 | | | | | | | | | 0.154 | 190 |
| VEBHUG | CoRE (2019) | 0.51 | 3751 | 1917 | 0.85 | 1.7 | 17.3 | 9.8 | 0.271 | 194 |
| FUYCIN | CoRE (2019) | 0.44 | 4293 | 1877 | 0.83 | 1.9 | 11.4 | 11.1 | 0.314 | 192 |
| ja074366osi 20070816_0 31204 | CoRE (2019) | 0.60 | 3703 | 2203 | 0.81 | 1.4 | 15.0 | 8.0 | 0.225 | 187 |
| PEVQOY | CoRE (2019) | 0.61 | 3637 | 2232 | 0.81 | 1.3 | 14.8 | 7.9 | 0.215 | 184 |
| XIYYEL | CoRE (2019) | 0.72 | 3203 | 2313 | 0.79 | 1.1 | 8.5 | 8.2 | 0.185 | 186 |
| VUSKEA | CoRE (2019) | 0.59 | 3687 | 2193 | 0.80 | 1.3 | 15.0 | 8.0 | 0.223 | 185 |
| VUSKAW | CoRE (2019) | 0.59 | 3708 | 2205 | 0.80 | 1.3 | 15.0 | 8.0 | 0.223 | 185 |
| cg500192d_ si_003 | CoRE (2019) | 0.55 | 3732 | 2069 | 0.79 | 1.4 | 11.2 | 9.5 | 0.240 | 186 |
| EDUSIF | CoRE (2019) | 0.59 | 3751 | 2226 | 0.81 | 1.4 | 15.1 | 7.9 | 0.222 | 184 |
| LAWGOG | CoRE (2019) | 0.59 | 3785 | 2231 | 0.80 | 1.4 | 15.1 | 7.9 | 0.220 | 181 |
| LAWGEW | CoRE (2019) | 0.59 | 3769 | 2230 | 0.80 | 1.4 | 15.1 | 7.9 | 0.220 | 182 |
| COXHON | CoRE (2019) | 0.66 | 3486 | 2298 | 0.80 | 1.2 | 8.8 | 8.5 | 0.197 | 182 |
| LAWGIA | CoRE (2019) | 0.59 | 3776 | 2230 | 0.80 | 1.4 | 15.1 | 7.9 | 0.222 | 183 |
| LAWFOF | CoRE (2019) | 0.59 | 3788 | 2233 | 0.81 | 1.4 | 15.1 | 8.0 | 0.220 | 181 |
| HIFTOG01 | CoRE (2019) | 0.58 | 3799 | 2219 | 0.80 | 1.4 | 15.1 | 7.9 | 0.222 | 181 |
| LAWGUM | CoRE (2019) | 0.59 | 3790 | 2232 | 0.80 | 1.4 | 15.1 | 7.9 | 0.220 | 181 |
| LAWFUL | CoRE (2019) | 0.59 | 3779 | 2229 | 0.81 | 1.4 | 15.1 | 8.0 | 0.219 | 180 |
| LAWGAS | CoRE (2019) | 0.59 | 3787 | 2234 | 0.81 | 1.4 | 15.1 | 7.9 | 0.219 | 181 |
| MEJMOE | CoRE (2019) | 0.62 | 3622 | 2232 | 0.81 | 1.3 | 13.4 | 7.2 | 0.207 | 178 |
| NEYVEU | CoRE (2019) | 0.51 | 3905 | 2008 | 0.80 | 1.5 | 20.2 | 6.4 | 0.249 | 179 |
| ja5b00365_ si_002 | CoRE (2019) | 0.45 | 4503 | 2038 | 0.83 | 1.8 | 21.8 | 7.6 | 0.282 | 178 |
| ERIRIG | CoRE (2019) | 0.43 | 4770 | 2036 | 0.83 | 1.9 | 11.7 | 9.6 | 0.294 | 175 |
| ic2017598_ si_001 | CoRE (2019) | 0.61 | 3715 | 2263 | 0.80 | 1.3 | 14.9 | 7.9 | 0.210 | 178 |
| ICAQIO | CoRE (2019) | 0.40 | 4746 | 1915 | 0.83 | 2.0 | 20.4 | 8.0 | 0.312 | 176 |
| PEVQIS | CoRE (2019) | 0.61 | 3681 | 2230 | 0.81 | 1.3 | 14.9 | 7.8 | 0.211 | 178 |
| ICAQOU | CoRE (2019) | 0.41 | 4636 | 1916 | 0.82 | 2.0 | 20.3 | 7.9 | 0.303 | 175 |
| VAZTOG | CoRE (2019) | 0.59 | 3787 | 2234 | 0.80 | 1.4 | 15.1 | 7.9 | 0.213 | 175 |
| ICAROV | CoRE (2019) | 0.41 | 4744 | 1928 | 0.82 | 2.0 | 20.3 | 7.9 | 0.306 | 174 |
| VAZTUM | CoRE (2019) | 0.59 | 3797 | 2247 | 0.81 | 1.4 | 15.1 | 7.9 | 0.215 | 178 |
| KULMEK | CoRE (2019) | 0.66 | 3438 | 2269 | 0.75 | 1.1 | 13.2 | 7.5 | 0.191 | 176 |
| PEDRIA | CoRE (2019) | 0.59 | 3806 | 2245 | 0.81 | 1.4 | 15.1 | 7.9 | 0.210 | 173 |
| KINSEH | CoRE (2019) | 0.63 | 2959 | 1878 | 0.75 | 1.2 | 12.8 | 11.5 | 0.202 | 179 |
| HAFTOZ | CoRE (2019) | 0.55 | 3683 | 2040 | 0.78 | 1.4 | 15.4 | 7.5 | 0.224 | 173 |
| ja4015666_ si_002 | CoRE (2019) | 0.71 | 3127 | 2225 | 0.76 | 1.1 | 10.1 | 9.1 | 0.177 | 176 |
| ja4015666_ si_005 | CoRE (2019) | 0.72 | 3075 | 2224 | 0.75 | 1.0 | 10.1 | 9.0 | 0.175 | 177 |
| IYOWID | CoRE (2019) | 0.41 | 4764 | 1930 | 0.82 | 2.0 | 20.5 | 7.7 | 0.298 | 169 |
| EDUVOO | CoRE (2019) | 0.37 | 4790 | 1788 | 0.86 | 2.3 | 20.9 | 10.6 | 0.317 | 166 |
| FEFDEB | CoRE (2019) | 0.54 | 3959 | 2135 | 0.77 | 1.4 | 13.1 | 11.6 | 0.226 | 170 |
| ja4015666_ si_003 | CoRE (2019) | 0.72 | 3143 | 2257 | 0.75 | 1.0 | 10.1 | 9.0 | 0.175 | 175 |
| NEXVET | CoRE (2019) | 0.57 | 3880 | 2221 | 0.81 | 1.4 | 15.1 | 7.9 | 0.213 | 170 |
| acs.jpcc.6b0 8594_Zn2C d6MOF5_opt | CoRE (2019) | 0.63 | 3422 | 2151 | 0.81 | 1.3 | 14.7 | 8.1 | 0.189 | 166 |
| LIRFIB | CoRE (2019) | 0.55 | 4061 | 2253 | 0.80 | 1.4 | 9.2 | 8.8 | 0.213 | 165 |
| COXHIH | CoRE (2019) | 0.71 | 3273 | 2311 | 0.79 | 1.1 | 8.6 | 8.2 | 0.168 | 166 |
| CAVPEW | CoRE (2019) | 0.40 | 4794 | 1931 | 0.82 | 2.0 | 20.3 | 7.8 | 0.293 | 165 |
| QAMLEY | CoRE (2019) | 0.70 | 3269 | 2278 | 0.76 | 1.1 | 11.1 | 6.1 | 0.177 | 172 |
| COXHED | CoRE (2019) | 0.69 | 3357 | 2309 | 0.80 | 1.2 | 8.7 | 8.4 | 0.171 | 164 |
| ja5109535_ si_002 | CoRE (2019) | 0.65 | 3380 | 2199 | 0.77 | 1.2 | 17.5 | 7.7 | 0.188 | 171 |
| GURPUF | CoRE (2019) | 0.70 | 3384 | 2357 | 0.79 | 1.1 | 9.5 | 8.4 | 0.170 | 165 |
| CAVPIA | CoRE (2019) | 0.42 | 4733 | 1970 | 0.81 | 2.0 | 19.9 | 7.8 | 0.286 | 166 |
| ic101935f_si_002 | CoRE (2019) | 0.41 | 5095 | 2079 | 0.85 | 2.1 | 13.5 | 8.8 | 0.286 | 163 |

Table 6 shows usable capacities (pressure swing between 80 and 5 bar) and crystallographic properties of 50 promising non-CUS MOFs. Screening is conducted based on the DREIDING(MOF)/TraPPE(CH₄) interatomic potential.

TABLE 6

| MOF Name | Source | Density (g/cm³) | Gravimetric surface area (m²/g) | Volumetric surface area (m²/cm³) | Void fraction | Pore volume (cm³/g) | Large cavity diameter (Å) |
|---|---|---|---|---|---|---|---|
| HKUST-1 | | | | | | | |
| VEBHUG | CoRE (2019) | 0.51 | 3751 | 1917 | 0.85 | 1.7 | 17.3 |
| FUYCIN | CoRE (2019) | 0.44 | 4293 | 1877 | 0.83 | 1.9 | 11.4 |
| ja074366osi20070816_031204 | CoRE (2019) | 0.60 | 3703 | 2203 | 0.81 | 1.4 | 15.0 |
| XIYYEL | CoRE (2019) | 0.72 | 3203 | 2313 | 0.79 | 1.1 | 8.5 |
| cg500192d_si_003 | CoRE (2019) | 0.55 | 3732 | 2069 | 0.79 | 1.4 | 11.2 |
| VUSKAW | CoRE (2019) | 0.59 | 3708 | 2205 | 0.80 | 1.3 | 15.0 |
| VUSKEA | CoRE (2019) | 0.59 | 3687 | 2193 | 0.80 | 1.3 | 15.0 |
| PEVQOY | CoRE (2019) | 0.61 | 3637 | 2232 | 0.81 | 1.3 | 14.8 |
| EDUSIF | CoRE (2019) | 0.59 | 3751 | 2226 | 0.81 | 1.4 | 15.1 |
| LAWGIA | CoRE (2019) | 0.59 | 3776 | 2230 | 0.80 | 1.4 | 15.1 |
| LAWGEW | CoRE (2019) | 0.59 | 3769 | 2230 | 0.80 | 1.4 | 15.1 |
| COXHON | CoRE (2019) | 0.66 | 3486 | 2298 | 0.80 | 1.2 | 8.8 |
| LAWGUM | CoRE (2019) | 0.59 | 3790 | 2232 | 0.80 | 1.4 | 15.1 |
| LAWGOG | CoRE (2019) | 0.59 | 3785 | 2231 | 0.80 | 1.4 | 15.1 |
| LAWFOF | CoRE (2019) | 0.59 | 3788 | 2233 | 0.81 | 1.4 | 15.1 |
| LAWGAS | CoRE (2019) | 0.59 | 3787 | 2234 | 0.81 | 1.4 | 15.1 |
| HIFTOG01 | CoRE | 0.58 | 3799 | 2219 | 0.80 | 1.4 | 15.1 |
| | (2019) | | | | | | |
| LAWFUL | CoRE (2019) | 0.59 | 3779 | 2229 | 0.81 | 1.4 | 15.1 |
| KINSEH | CoRE (2019) | 0.63 | 2959 | 1878 | 0.75 | 1.2 | 12.8 |
| NEYVEU | CoRE (2019) | 0.51 | 3905 | 2008 | 0.80 | 1.5 | 20.2 |
| ic2017598_si_001 | CoRE (2019) | 0.61 | 3715 | 2263 | 0.80 | 1.3 | 14.9 |
| PEVQIS | CoRE (2019) | 0.61 | 3681 | 2230 | 0.81 | 1.3 | 14.9 |
| ja5b00365_si_002 | CoRE (2019) | 0.45 | 4503 | 2038 | 0.83 | 1.8 | 21.8 |
| MEJMOE | CoRE (2019) | 0.62 | 3622 | 2232 | 0.81 | 1.3 | 13.4 |
| VAZTUM | CoRE (2019) | 0.59 | 3797 | 2247 | 0.81 | 1.4 | 15.1 |
| ja4015666_si_005 | CoRE (2019) | 0.72 | 3075 | 2224 | 0.75 | 1.0 | 10.1 |
| ja4015666_si_002 | CoRE (2019) | 0.71 | 3127 | 2225 | 0.76 | 1.1 | 10.1 |
| KULMEK | CoRE (2019) | 0.66 | 3438 | 2269 | 0.75 | 1.1 | 13.2 |
| ICAQIO | CoRE (2019) | 0.40 | 4746 | 1915 | 0.83 | 2.0 | 20.4 |
| ERIRIG | CoRE (2019) | 0.43 | 4770 | 2036 | 0.83 | 1.9 | 11.7 |
| ICAQOU | CoRE (2019) | 0.41 | 4636 | 1916 | 0.82 | 2.0 | 20.3 |
| ja4015666_si_003 | CoRE (2019) | 0.72 | 3143 | 2257 | 0.75 | 1.0 | 10.1 |
| VAZTOG | CoRE (2019) | 0.59 | 3787 | 2234 | 0.80 | 1.4 | 15.1 |
| ICAROV | CoRE (2019) | 0.41 | 4744 | 1928 | 0.82 | 2.0 | 20.3 |
| HAFTOZ | CoRE (2019) | 0.55 | 3683 | 2040 | 0.78 | 1.4 | 15.4 |
| PEDRIA | CoRE (2019) | 0.59 | 3806 | 2245 | 0.81 | 1.4 | 15.1 |
| QAMLEY | CoRE (2019) | 0.70 | 3269 | 2278 | 0.76 | 1.1 | 11.1 |
| ic502725y_si_004 | CoRE (2019) | 1.57 | 1304 | 2049 | 0.64 | 0.4 | 9.6 |
| ja5109535_si_002 | CoRE (2019) | 0.65 | 3380 | 2199 | 0.77 | 1.2 | 17.5 |
| NEXVET | CoRE (2019) | 0.57 | 3880 | 2221 | 0.81 | 1.4 | 15.1 |
| FEFDEB | CoRE (2019) | 0.54 | 3959 | 2135 | 0.77 | 1.4 | 13.1 |
| WECBEN | CoRE (2019) | 0.99 | 3144 | 3119 | 0.70 | 0.7 | 6.5 |
| ABETIN | CoRE (2019) | 0.60 | 3811 | 2276 | 0.73 | 1.2 | 9.5 |
| IYOWID | CoRE (2019) | 0.41 | 4764 | 1930 | 0.82 | 2.0 | 20.5 |
| WUTBEU | CoRE (2019) | 0.75 | 2277 | 1719 | 0.75 | 1.0 | 12.7 |
| KEDJAG04 | CoRE (2019) | 1.07 | 2815 | 3013 | 0.69 | 0.6 | 5.6 |
| KEDJAG14 | CoRE (2019) | 1.06 | 2872 | 3042 | 0.69 | 0.7 | 5.6 |
| KEDJAG10 | CoRE (2019) | 1.06 | 2853 | 3032 | 0.69 | 0.7 | 5.6 |
| KEDJAG16 | CoRE (2019) | 1.06 | 2877 | 3044 | 0.69 | 0.7 | 5.6 |
| KEDJAG18 | CoRE (2019) | 1.05 | 2902 | 3061 | 0.70 | 0.7 | 5.7 |

In view of this computational analysis, in certain variations, a natural gas storage material comprises a porous metal-organic framework material having one or more sites for reversibly storing methane selected from the group consisting of: catena-((µ8-5-(3,5-bis(4-carboxyphenyl)phenyl)benzene-1,3-dicarboxylato)-diaqua-di-copper](UMCM-152), catena-(tetrakis(µ6-benzene-1,3,5-tribenzoate)-tris(µ2-4,4′-bipyridine)-hexa-copper) (DUT-23-Cu), catena-[(µ₄-Oxo)-tris(µ₄-thieno[3,2-b]thiophene-2,5-dicarboxylato)-tetra-zinc] (VEBHUG or IRMOF-20), catena-[bis(dimethylammonium) (µ-triphenylene-2,3,6,7,10,11-hexolato)-vanadium dihydrate] (FUYCIN or V-CAT-5), catena-[(m-oxido)-tris(m-benzene-1,4-dicarboxylato)-tetra-zinc(ii)] (ja074366osi20070816_031204 or IRMOF-3), catena-[hexakis(dimethylammonium) disulfate tris(m2-oxalato)-di-zinc] (XIYYEL), bis(m2-N′-(3-hydroxy-2-oxybenzylidene)-2-hydroxybenzohydrazide)-tetrakis(pyridine)-di-manganese dinitrate methanol solvate (cg500192d_si_003 or porph@MOM-13), catena-(hexakis(m4-Benzene-1,4-dicarboxylato)-bis(m4-oxo)-octa-zinc solvate trihydrate (VUSKAW or MOF-5), catena-(hexakis(m4-Benzene-1,4-dicarboxylato)-bis(m4-oxo)-octa-zinc solvate) (VUSKEA or MOF-5), catena-(tris(m7-2,2′-(Adipoylbis(azanediyl))diterephthalato)-bis(m4-oxo)-octa-zinc chloroform dimethylformamide solvate) (PEVQOY or IRMOF-3-AM4XL), catena-(tris(m4-Benzene-1,4-dicarboxylato)-(m4-oxo)-tetra-zinc heptakis(N,N-diethylformamide) trihydrate clathrate) (EDUSIF or MOF-5), and combinations thereof.

In certain variations, the MOF is selected to have better usable capacity for methane/natural gas storage than HKUST-1, for example, greater than or equal to about 190 cm³(STP)/cm³ under pressure swing conditions of 65 bar adsorption to 5 bar desorption at 298 K. Such a material may be selected from the group consisting of: catena-[bis(dimethylammonium) (µ-triphenylene-2,3,6,7,10,11-hexolato)-vanadium dihydrate] (FUYCIN or V-CAT-5), and combinations thereof.

In yet other variations, the MOF is selected to have a usable capacity for methane/natural gas storage that is equivalent to or better than HKUST-1, for example, greater than or equal to about 200 cm³(STP)/cm³ under pressure swing conditions of 80 bar adsorption to 5 bar desorption at 298 K. Such a natural gas storage material may comprise a porous metal-organic framework material having one or more sites for reversibly storing methane selected from the group consisting of: catena-((µ8-5-(3,5-bis(4-carboxyphenyl)phenyl)benzene-1,3-dicarboxylato)-diaqua-di-copper] (UMCM-152), catena-(tetrakis(µ6-benzene-1,3,5-tribenzoate)-tris(µ2-4,4′-bipyridine)-hexa-copper) (DUT-23-Cu), catena-[(µ₄-Oxo)-tris(µ₄-thieno[3,2-b]thiophene-2,5-dicarboxylato)-tetra-zinc] (VEBHUG or IRMOF-20), catena-[bis(dimethylammonium) (µ-triphenylene-2,3,6,7,10,11-hexolato)-vanadium dihydrate] (FUYCIN or V-CAT-5), catena-[(m-oxido)-tris(m-benzene-1,4-dicarboxylato)-tetra-zinc(ii)] (ja074366osi20070816_031204 or IRMOF-3), catena-[hexakis(dimethylammonium) disulfate tris(m2-oxalato)-di-zinc] (XIYYEL), bis(m2-N′-(3-hydroxy-2-oxybenzylidene)-2-hydroxybenzohydrazide)-tetrakis(pyridine)-di-manganese dinitrate methanol solvate (cg500192d_si_003 or porph@MOM-13), catena-(hexakis(m4-Benzene-1,4-dicarboxylato)-bis(m4-oxo)-octa-zinc solvate trihydrate (VUSKAW or MOF-5), catena-(hexakis(m4-Benzene-1,4-dicarboxylato)-bis(m4-oxo)-octa-zinc solvate) (VUSKEA or MOF-5), catena-(tris(m7-2,2′-(Adipoylbis(azanediyl))diterephthalato)-bis(m4-oxo)-octa-zinc chloroform dimethylformamide solvate) (PEVQOY or IRMOF-3-AM4XL), catena-(tris(m4-Benzene-1,4-dicarboxylato)-(m4-oxo)-tetra-zinc heptakis(N,N-diethylformamide) trihydrate clathrate) (EDUSIF or MOF-5), and combinations thereof.

In certain other variations, the MOF is selected to have better usable capacity for methane/natural gas storage than HKUST-1, for example, greater than or equal to about 202 cm³(STP)/cm³ under pressure swing conditions of 80 bar adsorption to 5 bar desorption at 298 K. Such a natural gas storage material may be selected from the group consisting of: catena-((µ8-5-(3,5-bis(4-carboxyphenyl)phenyl)benzene-1,3-dicarboxylato)-diaqua-di-copper](UMCM-152), catena-(tetrakis(µ6-benzene-1,3,5-tribenzoate)-tris(µ2-4,4′-bipyridine)-hexa-copper) (DUT-23-Cu), catena-[(µ₄-Oxo)-tris(µ₄-thieno[3,2-b]thiophene-2,5-dicarboxylato)-tetra-zinc] (VEBHUG or IRMOF-20), catena-[bis(dimethylammonium) (µ-triphenylene-2,3,6,7,10,11-hexolato)-vanadium dihydrate] (FUYCIN or V-CAT-5), catena-[(m-oxido)-tris(m-benzene-1,4-dicarboxylato)-tetra-zinc(ii)] (ja074366osi20070816_031204 or IRMOF-3), catena-[hexakis(dimethylammonium) disulfate tris(m2-oxalato)-di-zinc] (XIYYEL), catena-(hexakis(m4-Benzene-1,4-dicarboxylato)-bis(m4-oxo)-octa-zinc solvate) (VUSKEA or MOF-5), catena-(tris(m7-2,2′-(Adipoylbis(azanediyl))diterephthalato)-bis(m4-oxo)-octa-zinc chloroform dimethylformamide solvate) (PEVQOY or IRMOF-3-AM4XL), and combinations thereof.

For example, UMCM-152 (catena-((µ8-5-(3,5-bis(4-carboxyphenyl)phenyl)benzene-1,3-dicarboxylato)-diaqua-di-copper]) and DUT-23-Cu (catena-(tetrakis(µ6-benzene-1,3,5-tribenzoate)-tris(µ2-4,4′-bipyridine)-hexa-copper)) are identified through the above-described methodology as select sorbents with the potential to exceed the performance of HKUST-1. Additionally, UTSA-76 was also selected as it appears to be able to outperform HKUST-1 in the pressure range of 5-65 bar. Computational predictions are based on idealized MOF models that typically assume that all solvent, un-reacted salt, and disorder have been removed from the crystal structure. As these components can play a role in stabilizing some MOFs, there is no guarantee that a given MOF can be realized experimentally in its fully activated form. Therefore, experimental validation of predicted high-performance MOFs is performed here to validate the predictive modeling.

Thus, as will be described herein, remarkable methane uptake is demonstrated experimentally in three metal-organic frameworks (MOFs) identified by this computational screening: UTSA-76, UMCM-152 and DUT-23-Cu. These MOFs outperform the benchmark sorbent, HKUST-1, both volumetrically and gravimetrically for usable methane storage capacity, under a pressure swing of 80 to 5 bar at 298 K. Although high uptake at elevated pressure helps achieve this performance, a low density of high-affinity sites (coordinatively unsaturated metal centers) also contributes to a more complete release of stored gas at low pressure. The identification of these MOFs facilitates the efficient storage of natural gas via adsorption, and provides further evidence of the utility of computational screening in identifying MOFs that may have been overlooked as potential natural gas storage sorbents.

UTSA-76 (FIG. 2A) was synthesized with a BET surface area of 2,700 m²/g and pore volume of 1.09 cm³/g (at P/P₀ = 0.95) (Table 1). More specifically, ligand (organic linker) (H₄L2) synthesis of UTSA-76 is shown in the reaction scheme in FIG. 3. The linker for UTSA-76 was synthesized following the procedure described in Li, B., et al., “A Porous Metal-Organic Framework with Dynamic Pyrimidine Groups Exhibiting Record High Methane Storage Working Capacity, “J. Am. Chem. Soc., 136, pp. 6207-6210 (2014) with some modifications. Cu(NO₃)₂·2.5H₂O (80.2 mg, 0.344 mmol) and the organic linker, 5,5′-(pyrimidine-2,5-diyl) diisophthalic acid (H₄L2) (30.5 mg, 0.0742 mmol) were dissolved into mixed solvents (DMF/MeCN/H₂O, 6/1/1, v/v) of 8 mL, in a screw-capped vial (20 mL). Subsequently, 50 µL of 37% HCl was added to this mixture solution. The vial was capped, sonicated for approximately 5 minutes and heated in an oven at 85° C. for 24 hours. Blue block crystals were formed at the bottom of the vial, which were obtained by filtration and washed several times with DMF to form UTSA-76. Subsequently, crystals of UTSA-76 were exchanged with ethanol and immersed for three days. The supernatant liquid was replaced with fresh ethanol two times (20 mL × 2) each day. The MOF was then activated by treatment with flowing supercritical carbon dioxide (CO₂) for a period of 5 hours. Following supercritical activation, the crystals were further heated under dynamic vacuum (0.01 Torr) at 80° C. for 12 hours and then again at 110° C. for another 5 hours to afford purple crystalline material.

UTSA-76 exhibits a total volumetric (TV) methane uptake of 251 cm³ (STP) cm⁻ ³ and 266 cm³ (STP) cm⁻³ at pressures of 65 bar and 80 bar, respectively, at 298 K (Table 1). These TV values are lower than HKUST-1 for both maximum pressures. However, UTSA-76 exhibits significantly improved usable volumetric (UV) methane capacity of 210 cm³ (STP) cm⁻ ³ (80-5 bar) in comparison to HKUST-1 (200 cm³ (STP) cm⁻³).

The higher uptake of HKUST-1 relative to UTSA-76 in the 0-5 bar region is ascribed to the presence of a higher density of CUS in HKUST-1, resulting in a larger density of methane molecules adsorbed at low pressures. This observation is consistent with previous reports that the presence of CUS can have detrimental effects on the usable capacities of MOFs.

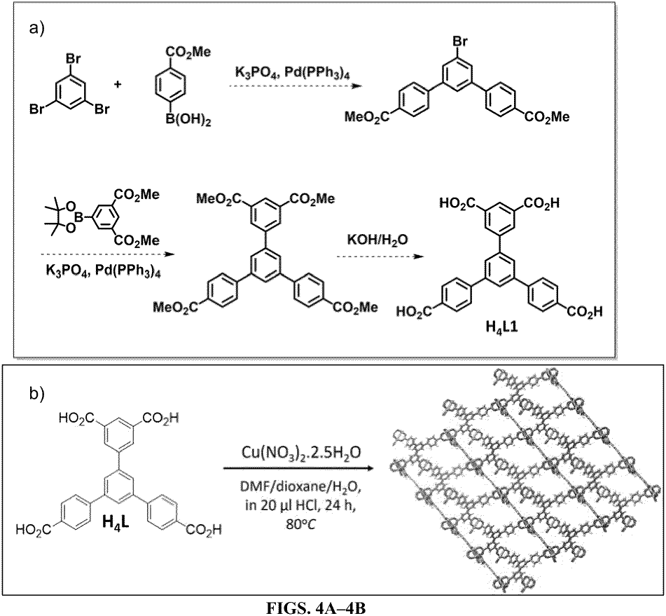

UMCM-152 was synthesized following a reported literature procedure in Schnobrich, J. K., et al. “Linker-directed vertex desymmetrization for the production of coordination polymers with high porosity,” J. Am. Chem. Soc., 132, pp. 13941-13948 (2010), with slight modifications. A reaction scheme for forming UMCM-152 is shown in FIG. 4B. UMCM-152 (FIG. 2B) is assembled from Cu(II) paddlewheel clusters connected through tetracarboxylated triphenyl benzene linkers and has a similar CUS density to UTSA-76. More specifically, ligand (organic linker) synthesis of the organic linker (H₄L1) for UMCM-152 is shown in the reaction scheme in FIG. 4A.

The linker 5′-(4 carboxyphenyl)carboxyphenyl)-[1,1′:3′,1″-terphenyl] 3,4″,5-tricarboxylic acid (H₄L1) (50.05 mg, 0.1036 mmol) was added to a solution of 0.005 M HCl in DMF/dioxane/H₂O (4:1:1, 10 ml). To this mixture, Cu(NO₃)₂·2.5H₂O (96.04 mg, 0.4129 mmol) was added, and the contents were sonicated until dissolved and then heated at 85° C. for about 18 hours in a screw-capped vial (20 mL). Blue block crystals were obtained which were washed repeatedly with DMF to ensure that it is free from unreacted linker. The MOF was exchanged with dry MeOH for three consecutive days, four times wash each day. The sample was further treated with dry acetone. After removing acetone by decanting, the sample was dried under vacuum (0.03 Torr) at room temperature (4 hours), and then further heated at 100° C. for 20 hours leading to a color change from sky blue to dark purple.

The linker has a trapezoidal geometry and two types of carboxylates: one from the isophthalate group and the other is a para-benzoate unit. The structure is composed of two cages (pore diameters: approximately 16.9 and 18.6 Å). One of the cages is formed from the faces of six linker molecules and twelve Cu(II) paddlewheel clusters while the other cage is defined by the edges of twelve linkers and six Cu(II) paddlewheels. These cages stack in an alternate fashion.

UMCM-152 was activated through conventional evacuation and heating. Crystals were washed with DMF to ensure that there is no uncoordinated linker present. The crystals were then exchanged with dry methanol (MeOH) for three consecutive days, four times each day. The sample was further treated with dry acetone similarly in order to remove any methanol solvates. After removing acetone by decanting, the sample was dried under vacuum (0.03 Torr) at room temperature (4 hours), and then further heated at 100° C. for 20 hours leading to a color change from sky blue to dark purple.

DUT-23-Cu (FIG. 2C) is composed of dodecahedral mesoporous cages with pto-like topology, constructed from Cu(II) and mixed linkers. The dative ligands fully cap the copper paddlewheels blocking guest access to the metal sites; hence, DUT-23-Cu is a non-CUS MOF.

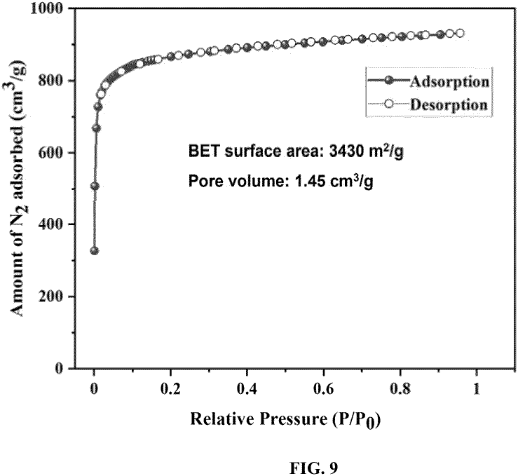

The synthesis of DUT-23-Cu is shown in FIG. 8 and was based on a published literature procedure described in Klein, N., et al., “Route to a family of robust, non-interpenetrated metal-organic frameworks with pto-like topology,” Chem.-Eur. J., 17, pp. 13007-13016 (2011), with slight modifications. Cu(NO₃)₂·2.5H₂O (241 mg, 1.036 mmol), bipyridine (42.20 mg, 0.2702 mmol), and 1,3,5-tris(4-carboxyphenyl)benzene (109.0 mg, 0.2486 mmol) were dissolved in a mixture of DMF (5 mL), EtOH (abs., 5 mL), and 50 µl of trifluoroacetic acid. The mixture was sonicated for 5 min and heated at 80° C. for 20 hours in a screw-capped vial (20 mL). Light-blue clear crystals of a single phase were obtained.

Crystals of DUT-23-Cu were washed with fresh DMF two times and then exchanged with ethanol. Ethanol exchange was performed for four days, with two exchanges each day. Ethanol solvated crystals were then activated by treatment (flowing) with supercritical carbon dioxide (CO₂) for a period of 7 hours. More specifically, ethanol solvated crystals were then activated by flowing liquid CO₂ at 2 mL/min flowrate for 2 h at room temperature, subsequently by supercritical CO₂ at a flow rate of 2 mL/min for 3 h at 55° C. and finally by supercritical CO₂ at a flow rate of 1 mL/min for 3 h at 55° C.

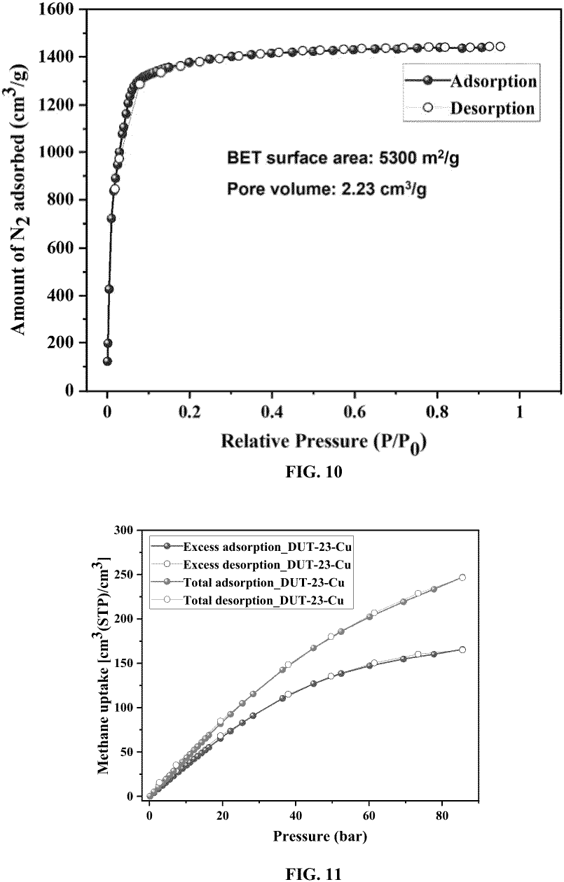

FIGS. 9 and 10 show the measured BET surface areas are 3,430 m²/g (UMCM-152) and 5,300 m²/g (DUT-23-Cu), with pore volumes (at P/P₀ = 0.95) of 1.45 cm³/g and 2.23 cm³/g respectively (Table 1). A total pore volume at P/P₀ = 0.95 is 2.23 cm³/g. FIG. 9 shows a nitrogen adsorption-desorption isotherm at 77 K and 1 atm pressure. The BET surface area was determined to be 3430 ± 30 m²/g (0.02<P/P₀<0.05). A total pore volume at P/P₀ = 0.95 is 1.45 cm³/g. FIG. 10 shows a nitrogen adsorption-desorption isotherm at 77 K and 1 atm pressure. The BET surface area was determined to be 3430 ± 30 m²/g (0.02<P/P₀<0.05). A total pore volume at P/P₀ = 0.95 is 1.45 cm³/g.

Methane adsorption isotherm measurements are conducted as follows. Highpressure methane adsorption isotherms were measured on a fully automated Sievert’s-type instrument PCT-Pro from SETARAM. Activated MOF samples were loaded into a stainless-steel sample holder inside a high-purity nitrogen glove box. The sample holder was then connected to the instrument’s analysis station via VCR fittings using a 0.5 inch fritted copper gasket of 2 micrometer and evacuated at room temperature for about an hour. The sample cell manual valve should be closed off before transferring the sample holder to the sorption instrument.

The sample holder was then immersed into a recirculating Dewar, that was connected to a temperature controlled programmable isothermal bath filled with a solution of ethylene glycol-H₂O and the sample temperature was maintained at 25° C. Helium was used to perform void volume measurements by the method of expansion from a known reservoir volume to the sample cell and then recording the change in the pressure, assuming negligible He adsorption. Generally, two volume calibrations are performed, one to determine the apparent volume at instrument temperature (Vₛₒ) and the other to determine the apparent volume at the experimental/sample temperature (Vₛₐ). These two apparent volumes are necessary to estimate the amount of gas adsorbed and desorbed by the sample.

Excess adsorption and desorption amounts were determined by the PCT-Pro software using a simple mass balance analysis as a function of the equilibrium pressure. The excess adsorption isotherms were further corrected using background adsorption corrections, measured with empty sample holder under similar experimental conditions. Total volumetric methane capacities were then determined using the following equation: nₜₒₜₐₗ = n_{excess} + Vₚ·ρ_{bulk} (T, P) where nₜₒₜₐₗ represents total volumetric adsorption capacity, n_{excess} represents the experimentally measured excess adsorption, Vₚ indicates the total pore volume as determined (at P/P0 = 0.95) from N₂ adsorption-desorption experiment at 77 K and ρ_{bulk} indicates the bulk density of methane at specific pressures (298 K) obtained from NIST REFPROF database.

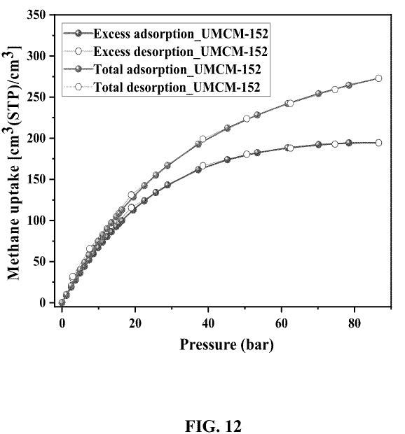

FIGS. 11 and 12 show experimental demonstration of methane adsorption isotherm of DUT-23-Cu MOF and UMCM-152 with methane uptake (cm³ (STP)/cm³) versus pressure (bar) prepared in accordance with certain aspects of the present disclosure.

As predicted computationally in accordance with certain aspects of the present disclosure, UMCM-152 exhibits remarkably high usable volumetric (UV) methane capacity that outperforms both HKUST-1 and UTSA-76, Table 1. The UV capacity of UMCM-152 is 207 cm³ (STP) cm⁻³ (9% greater than HKUST-1 and 6% greater than UTSA-76) and 226 cm³ (STP) cm⁻³ (13% > HKUST-1; 7% > UTSA-76) under 65-5 bar and 80-5 bar pressure swings, respectively, at 298 K. On the other hand, DUT-23-Cu exhibits a UV capacity of 190 cm³ (STP) cm⁻³ (identical to HKUST-1 and below UTSA-76) and 216 cm³ (STP) cm⁻³ (8% greater than HKUST-1 and 3% greater than UTSA-76) under a pressure swing of 65-5 bar and 80-5 bar, respectively, at 298 K. It should be noted that this performance is much higher than the Co analog: DUT-23-Co. Among all the MOFs examined, total volumetric (TV) methane uptake is still the highest in the case of HKUST-1 in both the high- and low-pressure regions. The increase in the UV capacities of UTSA-76, UMCM-152 and DUT-23-Cu relative to HKUST-1 is attributed to their comparatively low methane uptake at 5 bar (DUT-23-Cu: 21 cm³ (STP) cm⁻³ < UMCM-152: 40 cm³ (STP) cm⁻ ³ < UTSA-76: 56 cm³ (STP) cm⁻³< HKUST-1: 72 cm³ (STP) cm⁻³).

From this trend it appears that the success of DUT-23-Cu is ascribed to less adsorbed CH₄ at low pressure due to a lack of electrostatic interactions between CH₄ molecules and CUS (CUS are absent in DUT-23-Cu), rather high uptake at high pressure. This is an important design concern, and its manifestation is more subtle than the phenomenon in low temperature hydrogen sorbents where the presence of CUS can degrade deliverable capacity dramatically. Further, the uptake at 80 bar follows the order (DUT-23-Cu: 237 cm³ (STP) cm⁻³ < UMCM-152: 266 cm³ (STP) cm⁻³ and UTSA-76: 266 cm³ (STP) cm⁻³ < HKUST-1: 272 cm³ (STP) cm⁻³). Thus, larger pore volume in DUT-23-Cu contributes to having relatively lower volumetric uptakes both at 5 bar (21 cm³ (STP) cm⁻³) and 80 bar (237 cm³ (STP) cm⁻³) respectively. The trend can be understood in the context of previous studies on IRMOF-8-RT, another MOF with large pores, where only 50-65% of the pores are filled by adsorbed methane even at 89.4 bar. Reduction of pore size with additional linker substituents resulted in higher volumetric uptake in the derivatives of IRMOF-8-RT.

Although deliverable volumetric capacity is the primary figure of merit for an ANG system, other parameters are also important for enhanced natural gas/methane storage. For example, gravimetric capacity also influences vehicular performance because it impacts the mass of the ANG system. Earlier studies have demonstrated that gravimetric capacity depends on the pore volume and BET surface area of MOFs. For example, MOF-200, MOF-210, and Al-soc-MOF-1 with high BET surface areas of 4,530, 6,240, and 5,585 m²/g respectively, have high gravimetric uptakes but all suffer from low volumetric uptakes. On the other hand, HKUST-1 possesses high volumetric methane uptake at the expense of poor gravimetric capacity.

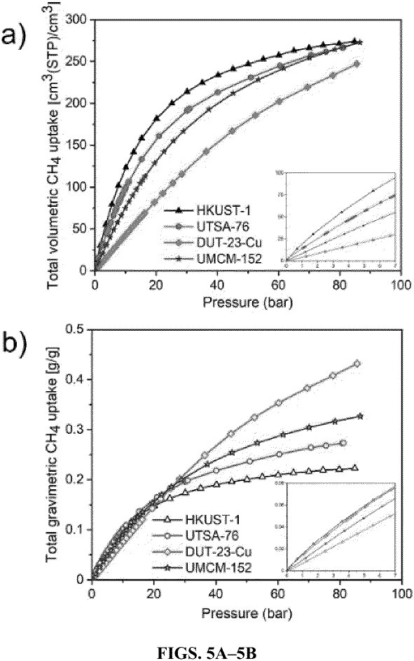

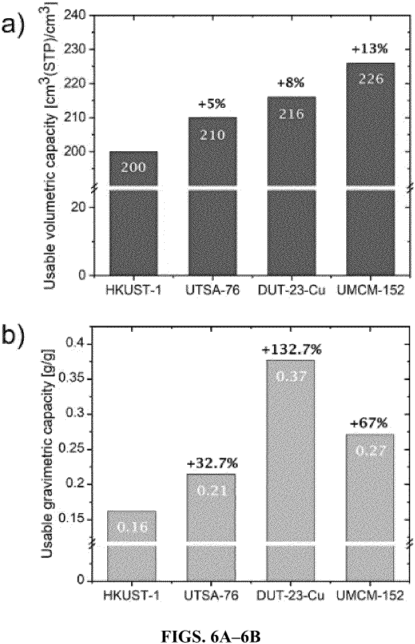

Therefore, a strategy to design MOFs with high UV capacity without compromising gravimetric methane uptake generally requires balancing surface area and porosity. In the context of the present application, UTSA-76, UMCM-152, and DUT-23-Cu all outperform HKUST-1 in terms of their respective total gravimetric (TG) methane uptakes for pressures exceeding approximately 30 bar. In fact, the TG uptake both at 65 and 80 bar follows the same order as the MOF’s respective surface areas: HKUST-1: 1836 m²/g < UTSA-76: 2700 m²/g < UMCM-152: 3430 m²/g < DUT-23-Cu: 5300 m²/g. However, at 5 bar, the gravimetric uptake follows a similar trend as does volumetric capacity, FIG. 5A (volumetric capacity) and 5B (gravimetric capacity). The usable gravimetric (UG) capacities of all three MOFs exceeds HKUST-1 under both pressure swing conditions, Table 1 and FIGS. 6A-6B.

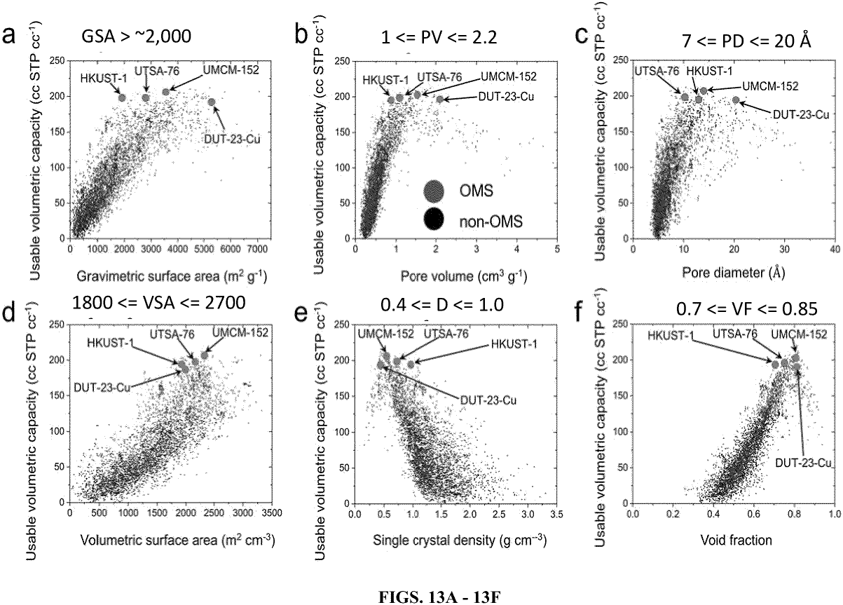

FIGS. 13A-13F show usable various properties for coordinatively unsaturated sites (CUS) and non-CUS metal-organic frameworks (MOFs). In certain variations, suitable MOFs fulfill one or more of the various performance criteria, namely gravimetric surface area (m²/g), pore volume (cm³/g), pore diameter (Å), volumetric surface area (m²/cm³), single crystal density (g/cm³), and void fraction specified herein as being advantageous in FIGS. 13A-13F. More specifically, 3,229 MOFs are identified as fulfilling at least one of these properties described in the context of FIGS. 13A-13F.

FIG. 13A shows usable volumetric methane capacity (cm³ (STP) cm⁻³) of the MOFs versus gravimetric surface area (m²/g). In accordance with certain aspects of the present disclosure, a gravimetric surface area (GSA) of the MOF is greater than or equal to about 2,000 m²/g, optionally greater than or equal to about 2,500 m²/g, optionally greater than or equal to about 3,000 m²/g, and in certain variations, optionally greater than or equal to about 4,000 m²/g. In FIG. 13A, HKUST-1, UTSA-76, UMCM-152, and DUT-23-Cu MOFs are all highlighted by the arrows. In total, 997 MOFs are identified as having a GSA of greater than or equal to about 2,000 m²/g, which are listed in Appendix A, incorporated herein by reference.

FIG. 13B shows usable volumetric methane capacity (cm³ (STP) cm⁻³) of the MOFs versus pore volume (cm³/g). In accordance with certain aspects of the present disclosure, a pore volume (PV) of the MOF is greater than or equal to about 1 cm³/g to less than or equal to about 2.2 cm³/g. In FIG. 13B, HKUST-1, UTSA-76, UMCM-152, and DUT-23-Cu MOFs are all highlighted by the arrows. In total, 354 MOFs are identified as having a PV of greater than or equal to about 1 cm³/g to less than or equal to about 2.2 cm³/g, which are listed in Appendix B, incorporated herein by reference.

FIG. 13C shows usable volumetric methane capacity (cm³ (STP) cm⁻³) of the MOFs versus pore diameter. In accordance with certain aspects of the present disclosure, a pore diameter of the MOF is greater than or equal to about 7 Angstrom (Å) to less than or equal to about 20 Angstrom. In FIG. 13C, HKUST-1, UTSA-76, UMCM-152, and DUT-23-Cu MOFs are all highlighted by the arrows. In total, 2,167 MOFs are identified as having a pore diameter of greater than or equal to about 7 Angstrom (Å) to less than or equal to about 20 Angstrom, which are listed in Appendix C, incorporated herein by reference.

FIG. 13D shows usable volumetric methane capacity (cm³ (STP) cm⁻³) of the MOFs versus volumetric surface area (m²/cm³). In accordance with certain aspects of the present disclosure, a volumetric surface area of the MOF is greater than or equal to about 1,800 m²/cm³ to less than or equal to about 2,700 m²/cm³. In FIG. 13D, HKUST-1, UTSA-76, UMCM-152, and DUT-23-Cu MOFs are all highlighted by the arrows. In total, 1,369 MOFs are identified as having a volumetric surface area of greater than or equal to about 1,800 m²/cm³ to less than or equal to about 2,700 m²/cm³, which are listed in Appendix D, incorporated herein by reference.

FIG. 13E shows usable volumetric methane capacity (cm³ (STP) cm⁻³) of the MOFs versus single crystal density (g/cm³). In accordance with certain aspects of the present disclosure, a single crystal density of the MOF is greater than or equal to about 0.4 g/cm³ to less than or equal to about 1 g/cm³. In FIG. 13E, HKUST-1, UTSA-76, UMCM-152, and DUT-23-Cu MOFs are all highlighted by the arrows. In total, 1,367 MOFs are identified as having a single crystal density of greater than or equal to about 0.4 g/cm³ to less than or equal to about 1 g/cm³, which are listed in Appendix E, incorporated herein by reference.

FIG. 13F shows usable volumetric methane capacity (cm³ (STP) cm⁻³) of the MOFs versus void fraction. In accordance with certain aspects of the present disclosure, a void fraction of the MOF is greater than or equal to about 0.7 to less than or equal to about 0.85. In FIG. 13F, HKUST-1, UTSA-76, UMCM-152, and DUT-23-Cu MOFs are all highlighted by the arrows. In total, 1,367 MOFs are identified as having a void fraction of greater than or equal to about 0.7 to less than or equal to about 0.85, which are listed in Appendix F, incorporated herein by reference.

In various aspects, each of UTSA-76, UMCM-152, and DUT-23-Cu MOFs fulfill the various performance criteria, namely gravimetric surface area (m²/g), pore volume (cm³/g), pore diameter (Å), volumetric surface area (m²/cm³), single crystal density (g/cm³), and void fraction specified as being advantageous in FIGS. 13A-13F. In certain variations, a suitable MOF for storing a gas comprising methane may have all of the following attributes: a usable methane storage capacity of greater than or equal to about 208 cm³(STP)/cm³ under pressure swing conditions of 80 bar adsorption to 5 bar desorption at 298 K, a gravimetric surface area of the MOF is greater than or equal to about 2,000 m²/g, optionally greater than or equal to about 2,800 m²/g, a pore volume of the MOF is greater than or equal to about 1 cm³/g to less than or equal to about 2.2 cm³/g, a pore diameter of the MOF is greater than or equal to about 7 Angstrom (Å) to less than or equal to about 20 Angstrom, a volumetric surface area of the MOF is greater than or equal to about 1,800 m²/cm³ to less than or equal to about 2,700 m²/cm³, a single crystal density of the MOF is greater than or equal to about 0.4 g/cm³ to less than or equal to about 1 g/cm³, and a void fraction of the MOF is greater than or equal to about 0.7 to less than or equal to about 0.85. In total, 151 MOFs fulfill all the criteria set forth in FIGS. 13A-13F, as reflected in Table 7 below. By way of non-limiting example, this includes MOFs such as UTSA-76, UMCM-152, and DUT-23-Cu.

TABLE 7

| | Source | Single crystal density (g/cm³) | Gravimetric surface area (m²/g) | Volumetric surface area (m²/cm³) | Void fraction | Pore volume (cm³/g) | Largest cavity diameter (Å) | Pore limiting diameter (Å) | Usable gravimetric capacity under pressure swing between 65 and 5 bar at 298 K (g/g) | Usable volumetric capacity under pressure swing between 65 and 5 bar at 298 K (cm³ STP/cm³) | Usable gravimetric capacity under pressure swing between 80 and 5 bar at 298 K (g/g) | Usable volumetric capacity under pressure swing between 80 and 5 bar at 298 K (cm³ STP/cm³) |
|---|---|---|---|---|---|---|---|---|---|---|---|---|
| ARAHIM01 | CoRE (2019) | 0.70 | 3269 | 2278 | 0.76 | 1.09 | 11.1 | 6.1 | 0.177 | 172 | 0.188 | 183 |
| QAMLEY | CoRE (2019) | 0.70 | 3269 | 2278 | 0.76 | 1.09 | 11.1 | 6.1 | 0.177 | 172 | 0.188 | 183 |
| ALEQIT | CoRE (2019) | 0.55 | 3732 | 2069 | 0.79 | 1.43 | 11.2 | 9.5 | 0.240 | 186 | 0.259 | 200 |
| cg500192d_si_003 | CoRE (2019) | 0.55 | 3732 | 2069 | 0.79 | 1.43 | 11.2 | 9.5 | 0.240 | 186 | 0.259 | 200 |
| ASUKEE | CoRE (2019) | 0.68 | 3184 | 2158 | 0.75 | 1.11 | 11.3 | 7.6 | 0.158 | 150 | 0.168 | 159 |
| ja406030p_si_005_manual | CoRE (2019) | 0.68 | 3184 | 2158 | 0.75 | 1.11 | 11.3 | 7.6 | 0.158 | 150 | 0.168 | 159 |
| AGUWUV | CoRE (2019) | 0.51 | 4131 | 2105 | 0.81 | 1.58 | 11.4 | 9.0 | 0.197 | 140 | 0.220 | 157 |
| ja512311a_si_007 | CoRE (2019) | 0.51 | 4131 | 2105 | 0.81 | 1.58 | 11.4 | 9.0 | 0.197 | 140 | 0.220 | 157 |
| ATIBOU02 | CoRE (2019) | 0.70 | 3197 | 2222 | 0.75 | 1.08 | 11.4 | 8.4 | 0.163 | 158 | 0.173 | 168 |
| ja406844r_si_002_clean | CoRE (2019) | 0.70 | 3197 | 2222 | 0.75 | 1.08 | 11.4 | 8.4 | 0.163 | 158 | 0.173 | 168 |
| AFIXES | CoRE (2019) | 0.48 | 4457 | 2124 | 0.82 | 1.72 | 11.4 | 9.6 | 0.317 | 211 | 0.338 | 225 |
| AJAYIT | CoRE (2019) | 0.61 | 3634 | 2205 | 0.80 | 1.32 | 11.5 | 8.6 | 0.240 | 203 | 0.256 | 217 |
| FATQID | CoRE (2019) | 0.61 | 3634 | 2205 | 0.80 | 1.32 | 11.5 | 8.6 | 0.240 | 203 | 0.256 | 217 |
| AQAJEI | CoRE (2019) | 0.61 | 3654 | 2225 | 0.77 | 1.26 | 11.6 | 9.8 | 0.224 | 191 | 0.238 | 202 |
| NUBPIL | CoRE (2019) | 0.61 | 3654 | 2225 | 0.77 | 1.26 | 11.6 | 9.8 | 0.224 | 191 | 0.238 | 202 |
| AQUCUM | CoRE (2019) | 0.62 | 3560 | 2219 | 0.76 | 1.22 | 11.9 | 7.2 | 0.211 | 183 | 0.222 | 194 |
| AHAMAY | CoRE (2019) | 0.49 | 4492 | 2208 | 0.81 | 1.64 | 11.9 | 9.0 | 0.242 | 166 | 0.264 | 181 |
| ja512311a_si_003 | CoRE (2019) | 0.49 | 4492 | 2208 | 0.81 | 1.64 | 11.9 | 9.0 | 0.242 | 166 | 0.264 | 181 |
| ARAFEF | CoRE (2019) | 0.62 | 3725 | 2307 | 0.76 | 1.23 | 11.9 | 9.1 | 0.190 | 164 | 0.204 | 177 |
| ja411887c_si_002 | CoRE (2019) | 0.62 | 3725 | 2307 | 0.76 | 1.23 | 11.9 | 9.1 | 0.190 | 164 | 0.204 | 177 |
| AMUXAI | CoRE (2019) | 0.52 | 4206 | 2179 | 0.78 | 1.50 | 11.9 | 10.7 | 0.255 | 185 | 0.272 | 196 |
| cm303749m_si_002 | CoRE (2019) | 0.52 | 4206 | 2179 | 0.78 | 1.50 | 11.9 | 10.7 | 0.255 | 185 | 0.272 | 196 |
| ALULID | CoRE (2019) | 0.47 | 4464 | 2101 | 0.79 | 1.67 | 12.0 | 10.5 | 0.244 | 160 | 0.266 | 175 |
| VEWKUF | CoRE (2019) | 0.47 | 4464 | 2101 | 0.79 | 1.67 | 12.0 | 10.5 | 0.244 | 160 | 0.266 | 175 |
| APAYUN | CoRE (2019) | 0.62 | 3698 | 2287 | 0.77 | 1.25 | 12.1 | 6.7 | 0.224 | 193 | 0.236 | 204 |
| LUYHAP | CoRE (2019) | 0.62 | 3698 | 2287 | 0.77 | 1.25 | 12.1 | 6.7 | 0.224 | 193 | 0.236 | 204 |
| ALANAD | CoRE (2019) | 0.52 | 4263 | 2227 | 0.79 | 1.52 | 12.3 | 9.7 | 0.264 | 193 | 0.281 | 205 |
| ANUGOG | CoRE (2019) | 0.62 | 3340 | 2079 | 0.78 | 1.25 | 12.5 | 9.0 | 0.207 | 180 | 0.217 | 189 |
| MATXAJ | CoRE (2019) | 0.62 | 3340 | 2079 | 0.78 | 1.25 | 12.5 | 9.0 | 0.207 | 180 | 0.217 | 189 |
| AMIMAL | CoRE (2019) | 0.53 | 3730 | 1990 | 0.78 | 1.46 | 12.6 | 10.1 | 0.225 | 167 | 0.243 | 181 |
| FAYQED | CoRE (2019) | 0.53 | 3730 | 1990 | 0.78 | 1.46 | 12.6 | 10.1 | 0.225 | 167 | 0.243 | 181 |
| ATAYAX | CoRE (2019) | 0.68 | 3326 | 2254 | 0.75 | 1.11 | 12.6 | 6.5 | 0.175 | 166 | 0.184 | 174 |
| EPISOM | CoRE (2019) | 0.68 | 3326 | 2254 | 0.75 | 1.11 | 12.6 | 6.5 | 0.175 | 166 | 0.184 | 174 |
| AQODOA | CoRE (2019) | 0.69 | 3237 | 2218 | 0.76 | 1.12 | 12.6 | 7.0 | 0.191 | 183 | 0.201 | 192 |
| FIFGIM | CoRE (2019) | 0.69 | 3237 | 2218 | 0.76 | 1.12 | 12.6 | 7.0 | 0.191 | 183 | 0.201 | 192 |
| ALUJIB | CoRE (2019) | 0.70 | 3225 | 2272 | 0.79 | 1.12 | 12.7 | 7.9 | 0.190 | 187 | 0.202 | 198 |
| j.inoche.2015.03.054_CIFs | CoRE (2019) | 0.70 | 3225 | 2272 | 0.79 | 1.12 | 12.7 | 7.9 | 0.190 | 187 | 0.202 | 198 |
| APETAS | CoRE (2019) | 0.59 | 3797 | 2247 | 0.77 | 1.30 | 12.9 | 9.9 | 0.215 | 178 | 0.229 | 189 |
| HUFKUQ | CoRE (2019) | 0.59 | 3797 | 2247 | 0.77 | 1.30 | 12.9 | 9.9 | 0.215 | 178 | 0.229 | 189 |
| AGAYIQ | CoRE (2019) | 0.53 | 3857 | 2030 | 0.81 | 1.54 | 13.0 | 10.5 | 0.248 | 182 | 0.269 | 198 |
| OLOGEC | CoRE (2019) | 0.53 | 3857 | 2030 | 0.81 | 1.54 | 13.0 | 10.5 | 0.248 | 182 | 0.269 | 198 |
| APEBED | CoRE (2019) | 0.54 | 3959 | 2135 | 0.77 | 1.43 | 13.1 | 11.6 | 0.226 | 170 | 0.247 | 186 |
| FEFDEB_ manual | CoRE (2019) | 0.54 | 3959 | 2135 | 0.77 | 1.43 | 13.1 | 11.6 | 0.226 | 170 | 0.247 | 186 |
| AFUPEX | CoRE (2019) | 0.45 | 4658 | 2109 | 0.81 | 1.79 | 13.2 | 9.8 | 0.339 | 214 | 0.359 | 227 |
| ASEJOZ01 | CoRE (2019) | 0.69 | 3286 | 2270 | 0.75 | 1.09 | 13.2 | 11.6 | 0.184 | 178 | 0.197 | 190 |
| ic502643m_si_007 | CoRE (2019) | 0.69 | 3286 | 2270 | 0.75 | 1.09 | 13.2 | 11.6 | 0.184 | 178 | 0.197 | 190 |
| ASANAL | CoRE (2019) | 0.66 | 3438 | 2269 | 0.75 | 1.14 | 13.2 | 7.5 | 0.191 | 176 | 0.206 | 190 |
| KULMEK | CoRE (2019) | 0.66 | 3438 | 2269 | 0.75 | 1.14 | 13.2 | 7.5 | 0.191 | 176 | 0.206 | 190 |
| AMAFOK | CoRE (2019) | 0.54 | 3625 | 1971 | 0.78 | 1.44 | 13.2 | 12.5 | 0.240 | 182 | 0.259 | 196 |
| FUNCEX | CoRE (2019) | 0.54 | 3625 | 1971 | 0.78 | 1.44 | 13.2 | 12.5 | 0.240 | 182 | 0.259 | 196 |
| ALULEZ | CoRE (2019) | 0.55 | 3985 | 2174 | 0.79 | 1.44 | 13.3 | 7.6 | 0.252 | 192 | 0.270 | 206 |
| CAJQIP | CoRE (2019) | 0.55 | 3985 | 2174 | 0.79 | 1.44 | 13.3 | 7.6 | 0.252 | 192 | 0.270 | 206 |
| APACAX | CoRE (2019) | 0.57 | 3358 | 1930 | 0.77 | 1.35 | 13.3 | 11.7 | 0.223 | 179 | 0.240 | 193 |
| jacs.6b09113_ja6b09113_si_002 | CoRE (2019) | 0.57 | 3358 | 1930 | 0.77 | 1.35 | 13.3 | 11.7 | 0.223 | 179 | 0.240 | 193 |
| AHEBAS | CoRE (2019) | 0.62 | 3622 | 2232 | 0.81 | 1.31 | 13.4 | 7.2 | 0.207 | 178 | 0.227 | 196 |
| MEJMOE | CoRE (2019) | 0.62 | 3622 | 2232 | 0.81 | 1.31 | 13.4 | 7.2 | 0.207 | 178 | 0.227 | 196 |
| ALURAB | CoRE (2019) | 0.48 | 4197 | 2019 | 0.79 | 1.63 | 13.6 | 8.6 | 0.278 | 187 | 0.303 | 204 |
| FAGQAI | CoRE (2019) | 0.48 | 4197 | 2019 | 0.79 | 1.63 | 13.6 | 8.6 | 0.278 | 187 | 0.303 | 204 |
| ALEJIM | CoRE (2019) | 0.60 | 3755 | 2269 | 0.79 | 1.31 | 13.6 | 13.3 | 0.220 | 186 | 0.232 | 196 |
| ic502643m_si_011 | CoRE (2019) | 0.60 | 3755 | 2269 | 0.79 | 1.31 | 13.6 | 13.3 | 0.220 | 186 | 0.232 | 196 |
| AMALND | CoRE (2019) | 0.56 | 3777 | 2129 | 0.78 | 1.39 | 13.8 | 8.0 | 0.243 | 191 | 0.258 | 203 |
| cg301577a_si_002 | CoRE (2019) | 0.56 | 3777 | 2129 | 0.78 | 1.39 | 13.8 | 8.0 | 0.243 | 191 | 0.258 | 203 |
| AFOVAT | CoRE (2019) | 0.54 | 3872 | 2106 | 0.82 | 1.50 | 13.8 | 9.9 | 0.281 | 214 | 0.300 | 228 |
| ALAMUW | CoRE (2019) | 0.57 | 4061 | 2306 | 0.79 | 1.40 | 13.9 | 6.8 | 0.258 | 205 | 0.273 | 217 |
| APAYIB | CoRE (2019) | 0.62 | 3432 | 2114 | 0.77 | 1.25 | 13.9 | 9.2 | 0.217 | 187 | 0.233 | 200 |
| ASIQEA | CoRE (2019) | 0.63 | 3345 | 2119 | 0.75 | 1.19 | 13.9 | 7.4 | 0.194 | 172 | 0.206 | 182 |
| NIGDEO | CoRE (2019) | 0.63 | 3345 | 2119 | 0.75 | 1.19 | 13.9 | 7.4 | 0.194 | 172 | 0.206 | 182 |
| AQEQIW | CoRE (2019) | 0.62 | 3550 | 2210 | 0.77 | 1.23 | 14.0 | 7.4 | 0.201 | 175 | 0.212 | 184 |
| NIGDIS | CoRE (2019) | 0.62 | 3550 | 2210 | 0.77 | 1.23 | 14.0 | 7.4 | 0.201 | 175 | 0.212 | 184 |
| APEBEE | CoRE (2019) | 0.65 | 3222 | 2097 | 0.77 | 1.18 | 14.1 | 9.5 | 0.193 | 175 | 0.205 | 186 |
| OKABAE | CoRE (2019) | 0.65 | 3222 | 2097 | 0.77 | 1.18 | 14.1 | 9.5 | 0.193 | 175 | 0.205 | 186 |
| ARUDAU | CoRE (2019) | 0.67 | 3453 | 2302 | 0.76 | 1.14 | 14.2 | 6.5 | 0.184 | 171 | 0.194 | 180 |
| FAMQAO | CoRE (2019) | 0.67 | 3453 | 2302 | 0.76 | 1.14 | 14.2 | 6.5 | 0.184 | 171 | 0.194 | 180 |
| ADODII | CoRE (2019) | 0.43 | 4497 | 1932 | 0.82 | 1.91 | 14.5 | 11.9 | 0.242 | 145 | 0.277 | 166 |
| AGONEQ | CoRE (2019) | 0.63 | 3422 | 2151 | 0.81 | 1.29 | 14.7 | 8.1 | 0.189 | 166 | 0.211 | 185 |
| AGARUW | CoRE (2019) | 0.61 | 3637 | 2232 | 0.81 | 1.32 | 14.8 | 7.9 | 0.215 | 184 | 0.236 | 202 |
| PEVQOY_h | CoRE (2019) | 0.61 | 3637 | 2232 | 0.81 | 1.32 | 14.8 | 7.9 | 0.215 | 184 | 0.236 | 202 |
| AKEDIF | CoRE (2019) | 0.61 | 3715 | 2263 | 0.80 | 1.31 | 14.9 | 7.9 | 0.210 | 178 | 0.228 | 194 |
| ic2017598_si_001_h | CoRE (2019) | 0.61 | 3715 | 2263 | 0.80 | 1.31 | 14.9 | 7.9 | 0.210 | 178 | 0.228 | 194 |
| AHEQAH | CoRE (2019) | 0.61 | 3681 | 2230 | 0.81 | 1.33 | 14.9 | 7.8 | 0.211 | 178 | 0.228 | 193 |
| PEVQIS | CoRE (2019) | 0.61 | 3681 | 2230 | 0.81 | 1.33 | 14.9 | 7.8 | 0.211 | 178 | 0.228 | 193 |
| AJINOY | CoRE (2019) | 0.59 | 3708 | 2205 | 0.80 | 1.35 | 15.0 | 8.0 | 0.223 | 185 | 0.241 | 200 |
| VUSKAW | CoRE (2019) | 0.59 | 3708 | 2205 | 0.80 | 1.35 | 15.0 | 8.0 | 0.223 | 185 | 0.241 | 200 |
| AJAMEF | CoRE (2019) | 0.59 | 3687 | 2193 | 0.80 | 1.35 | 15.0 | 8.0 | 0.223 | 185 | 0.243 | 202 |
| VUSKEA | CoRE (2019) | 0.59 | 3687 | 2193 | 0.80 | 1.35 | 15.0 | 8.0 | 0.223 | 185 | 0.243 | 202 |
| AGESIP | CoRE (2019) | 0.60 | 3703 | 2203 | 0.81 | 1.36 | 15.0 | 8.0 | 0.225 | 187 | 0.246 | 204 |
| ja074366osi20070816_031204 | CoRE (2019) | 0.60 | 3703 | 2203 | 0.81 | 1.36 | 15.0 | 8.0 | 0.225 | 187 | 0.246 | 204 |
| AGIREP | CoRE (2019) | 0.59 | 3751 | 2226 | 0.81 | 1.36 | 15.1 | 7.9 | 0.222 | 184 | 0.241 | 200 |
| EDUSIF | CoRE (2019) | 0.59 | 3751 | 2226 | 0.81 | 1.36 | 15.1 | 7.9 | 0.222 | 184 | 0.241 | 200 |
| AGONAM | CoRE (2019) | 0.57 | 3880 | 2221 | 0.81 | 1.41 | 15.1 | 7.9 | 0.213 | 170 | 0.232 | 186 |
| NEXVET | CoRE (2019) | 0.57 | 3880 | 2221 | 0.81 | 1.41 | 15.1 | 7.9 | 0.213 | 170 | 0.232 | 186 |
| AHOKIR | CoRE (2019) | 0.59 | 3769 | 2230 | 0.80 | 1.36 | 15.1 | 7.9 | 0.220 | 182 | 0.241 | 199 |
| LAWGEW | CoRE (2019) | 0.59 | 3769 | 2230 | 0.80 | 1.36 | 15.1 | 7.9 | 0.220 | 182 | 0.241 | 199 |
| AFUKIX | CoRE (2019) | 0.59 | 3797 | 2247 | 0.81 | 1.37 | 15.1 | 7.9 | 0.215 | 178 | 0.231 | 191 |
| VAZTUM | CoRE (2019) | 0.59 | 3797 | 2247 | 0.81 | 1.37 | 15.1 | 7.9 | 0.215 | 178 | 0.231 | 191 |
| AHUFIU | CoRE (2019) | 0.59 | 3776 | 2230 | 0.80 | 1.36 | 15.1 | 7.9 | 0.222 | 183 | 0.240 | 198 |
| LAWGIA | CoRE (2019) | 0.59 | 3776 | 2230 | 0.80 | 1.36 | 15.1 | 7.9 | 0.222 | 183 | 0.240 | 198 |
| AJOXAA | CoRE (2019) | 0.59 | 3787 | 2234 | 0.80 | 1.36 | 15.1 | 7.9 | 0.213 | 175 | 0.233 | 192 |
| VAZTOG | CoRE (2019) | 0.59 | 3787 | 2234 | 0.80 | 1.36 | 15.1 | 7.9 | 0.213 | 175 | 0.233 | 192 |
| AHOBEG | CoRE (2019) | 0.59 | 3785 | 2231 | 0.80 | 1.36 | 15.1 | 7.9 | 0.220 | 181 | 0.242 | 199 |
| LAWGOG | CoRE (2019) | 0.59 | 3785 | 2231 | 0.80 | 1.36 | 15.1 | 7.9 | 0.220 | 181 | 0.242 | 199 |
| AHUTIH | CoRE (2019) | 0.58 | 3799 | 2219 | 0.80 | 1.37 | 15.1 | 7.9 | 0.222 | 181 | 0.242 | 197 |
| HIFTOG01 | CoRE (2019) | 0.58 | 3799 | 2219 | 0.80 | 1.37 | 15.1 | 7.9 | 0.222 | 181 | 0.242 | 197 |
| AFOYOK | CoRE (2019) | 0.59 | 3787 | 2234 | 0.81 | 1.38 | 15.1 | 7.9 | 0.219 | 181 | 0.238 | 196 |
| LAWGAS | CoRE (2019) | 0.59 | 3787 | 2234 | 0.81 | 1.38 | 15.1 | 7.9 | 0.219 | 181 | 0.238 | 196 |
| AGABIU | CoRE (2019) | 0.59 | 3806 | 2245 | 0.81 | 1.38 | 15.1 | 7.9 | 0.210 | 173 | 0.231 | 190 |
| PEDRIA | CoRE (2019) | 0.59 | 3806 | 2245 | 0.81 | 1.38 | 15.1 | 7.9 | 0.210 | 173 | 0.231 | 190 |
| AHOJUC | CoRE (2019) | 0.59 | 3790 | 2232 | 0.80 | 1.36 | 15.1 | 7.9 | 0.220 | 181 | 0.240 | 197 |
| LAWGUM | CoRE (2019) | 0.59 | 3790 | 2232 | 0.80 | 1.36 | 15.1 | 7.9 | 0.220 | 181 | 0.240 | 197 |
| AFOYIE | CoRE (2019) | 0.59 | 3779 | 2229 | 0.81 | 1.38 | 15.1 | 8.0 | 0.219 | 180 | 0.239 | 197 |
| LAWFUL | CoRE (2019) | 0.59 | 3779 | 2229 | 0.81 | 1.38 | 15.1 | 8.0 | 0.219 | 180 | 0.239 | 197 |
| AFOYEB | CoRE (2019) | 0.59 | 3788 | 2233 | 0.81 | 1.38 | 15.1 | 8.0 | 0.220 | 181 | 0.240 | 198 |
| LAWFOF | CoRE (2019) | 0.59 | 3788 | 2233 | 0.81 | 1.38 | 15.1 | 8.0 | 0.220 | 181 | 0.240 | 198 |
| AMIKOX | CoRE (2019) | 0.55 | 3683 | 2040 | 0.78 | 1.41 | 15.4 | 7.5 | 0.224 | 173 | 0.244 | 189 |
| HAFTOZ | CoRE (2019) | 0.55 | 3683 | 2040 | 0.78 | 1.41 | 15.4 | 7.5 | 0.224 | 173 | 0.244 | 189 |
| AHOKOX | CoRE (2019) | 0.46 | 4299 | 1977 | 0.80 | 1.75 | 15.5 | 10.5 | 0.243 | 156 | 0.272 | 175 |
| KARNAU | CoRE (2019) | 0.46 | 4299 | 1977 | 0.80 | 1.75 | 15.5 | 10.5 | 0.243 | 156 | 0.272 | 175 |
| ALULAV | CoRE (2019) | 0.56 | 3942 | 2205 | 0.79 | 1.41 | 15.6 | 9.0 | 0.258 | 201 | 0.270 | 211 |
| ANENEN | CoRE (2019) | 0.54 | 3858 | 2079 | 0.78 | 1.44 | 15.7 | 6.1 | 0.251 | 189 | 0.266 | 200 |
| COCMOY | CoRE (2019) | 0.54 | 3858 | 2079 | 0.78 | 1.44 | 15.7 | 6.1 | 0.251 | 189 | 0.266 | 200 |
| ADODOO | CoRE (2019) | 0.47 | 4152 | 1931 | 0.82 | 1.77 | 15.8 | 12.7 | 0.290 | 188 | 0.315 | 205 |
| FAHPOV | CoRE (2019) | 0.47 | 4152 | 1931 | 0.82 | 1.77 | 15.8 | 12.7 | 0.290 | 188 | 0.315 | 205 |
| AGIMOU | CoRE (2019) | 0.46 | 4230 | 1949 | 0.81 | 1.76 | 15.9 | 10.4 | 0.319 | 206 | 0.343 | 221 |
| POHWIU | CoRE (2019) | 0.46 | 4230 | 1949 | 0.81 | 1.76 | 15.9 | 10.4 | 0.319 | 206 | 0.343 | 221 |
| AQETIA | CoRE (2019) | 0.63 | 3636 | 2275 | 0.77 | 1.23 | 17.2 | 6.7 | 0.212 | 185 | 0.225 | 196 |
| AFUKET | CoRE (2019) | 0.56 | 3595 | 2002 | 0.81 | 1.46 | 17.3 | 8.1 | 0.209 | 163 | 0.231 | 180 |
| TEQPEM_SL | CoRE (2019) | 0.56 | 3595 | 2002 | 0.81 | 1.46 | 17.3 | 8.1 | 0.209 | 163 | 0.231 | 180 |
| AQALOU | CoRE (2019) | 0.65 | 3380 | 2199 | 0.77 | 1.18 | 17.5 | 7.7 | 0.188 | 171 | 0.201 | 182 |
| ja5109535_si_002 | CoRE (2019) | 0.65 | 3380 | 2199 | 0.77 | 1.18 | 17.5 | 7.7 | 0.188 | 171 | 0.201 | 182 |
| AGUVOO _charged | CoRE (2019) | 0.49 | 4145 | 2044 | 0.81 | 1.63 | 17.5 | 9.2 | 0.218 | 150 | 0.245 | 169 |
| ja507947d_si_001 | CoRE (2019) | 0.49 | 4145 | 2044 | 0.81 | 1.63 | 17.5 | 9.2 | 0.218 | 150 | 0.245 | 169 |
| AKOBAF | CoRE (2019) | 0.59 | 3830 | 2255 | 0.80 | 1.35 | 17.8 | 7.5 | 0.239 | 196 | 0.254 | 209 |
| PEWLUA | CoRE (2019) | 0.59 | 3830 | 2255 | 0.80 | 1.35 | 17.8 | 7.5 | 0.239 | 196 | 0.254 | 209 |
| ALURIJ | CoRE (2019) | 0.63 | 3520 | 2223 | 0.78 | 1.24 | 18.1 | 6.7 | 0.187 | 165 | 0.197 | 174 |
| AMILOY | CoRE (2019) | 0.59 | 3730 | 2209 | 0.78 | 1.32 | 18.2 | 7.1 | 0.218 | 180 | 0.230 | 191 |
| AQMAND | CoRE (2019) | 0.63 | 3491 | 2197 | 0.77 | 1.22 | 18.2 | 6.6 | 0.206 | 181 | 0.218 | 192 |
| AFOTUL | CoRE (2019) | 0.54 | 3650 | 1958 | 0.82 | 1.52 | 18.5 | 9.4 | 0.250 | 188 | 0.273 | 204 |
| LIKDOA | CoRE (2019) | 0.54 | 3650 | 1958 | 0.82 | 1.52 | 18.5 | 9.4 | 0.250 | 188 | 0.273 | 204 |
| AHOKAJ | CoRE (2019) | 0.47 | 4164 | 1955 | 0.80 | 1.71 | 18.6 | 7.9 | 0.249 | 163 | 0.276 | 181 |
| MUBZUG | CoRE (2019) | 0.47 | 4164 | 1955 | 0.80 | 1.71 | 18.6 | 7.9 | 0.249 | 163 | 0.276 | 181 |
| AFOYAW | CoRE (2019) | 0.44 | 4507 | 1990 | 0.81 | 1.84 | 18.7 | 7.1 | 0.255 | 157 | 0.286 | 176 |
| MUBZOA | CoRE (2019) | 0.44 | 4507 | 1990 | 0.81 | 1.84 | 18.7 | 7.1 | 0.255 | 157 | 0.286 | 176 |
| AQUDAT | CoRE (2019) | 0.61 | 3636 | 2221 | 0.76 | 1.25 | 18.8 | 6.4 | 0.216 | 184 | 0.229 | 195 |
| ja110042b_si_003 | CoRE (2019) | 0.61 | 3636 | 2221 | 0.76 | 1.25 | 18.8 | 6.4 | 0.216 | 184 | 0.229 | 195 |
| ALOLES_ion_b | CoRE (2019) | 0.56 | 3858 | 2169 | 0.79 | 1.41 | 18.9 | 6.6 | 0.234 | 184 | 0.250 | 197 |
| MUDTAH | CoRE (2019) | 0.56 | 3858 | 2169 | 0.79 | 1.41 | 18.9 | 6.6 | 0.234 | 184 | 0.250 | 197 |
| ALUKIC | CoRE (2019) | 0.56 | 3853 | 2155 | 0.79 | 1.41 | 19.1 | 6.6 | 0.242 | 189 | 0.258 | 202 |
| MUDTEL | CoRE (2019) | 0.56 | 3853 | 2155 | 0.79 | 1.41 | 19.1 | 6.6 | 0.242 | 189 | 0.258 | 202 |
| ALALUU | CoRE (2019) | 0.51 | 3905 | 2008 | 0.80 | 1.55 | 20.2 | 6.4 | 0.249 | 179 | 0.271 | 195 |
| NEYVEU | CoRE (2019) | 0.51 | 3905 | 2008 | 0.80 | 1.55 | 20.2 | 6.4 | 0.249 | 179 | 0.271 | 195 |
| ADOBOL_ charged | CoRE (2019) | 0.41 | 4636 | 1916 | 0.82 | 1.99 | 20.3 | 7.9 | 0.303 | 175 | 0.334 | 193 |

In certain other variations, a suitable MOF for storing a gas comprising methane may have all of the following attributes: a usable methane storage capacity of greater than or equal to about 216 cm³(STP)/cm³ under pressure swing conditions of 80 bar adsorption to 5 bar desorption at 298 K, a gravimetric surface area of the MOF is greater than or equal to about 2,800 m²/g, and a pore volume of greater than or equal to about 1.1 cm³/g to less than or equal to about 2.2 cm³/g. By way of non-limiting example, such MOFs include UMCM-152, and DUT-23-Cu.

In accordance with various aspects of the present disclosure, MOFs for methane sorption were identified computationally. Based on these predictions, as noted above, three MOFs, UTSA-76, UMCM-152 and DUT-23-Cu, were synthesized and their measured capacities were observed to surpass the usable capacity of HKUST-1, the benchmark for methane storage, under pressure swing conditions. Specifically, UMCM-152 is demonstrated to outperform the benchmark MOFs, HKUST-1 and UTSA-76, both on a volumetric and gravimetric basis. Although high uptake at elevated pressure contributes to this performance, there is an additional requirement that the density of high affinity sites (coordinatively unsaturated metal centers) is low enough to allow relatively complete release of stored gas at low pressure. The utility of mining existing MOF databases for promising materials is demonstrated and provides an efficient discovery paradigm for measurements, such as high pressure methane storage, that are challenging experimentally.

In one variation, the natural gas storage material comprises a porous metal-organic framework material that is UMCM-152. In certain variations, the usable methane storage capacity is greater than or equal to about 226 cm³ (STP)/cm³.

| Name | Density (g/cm³) | Gravimetric surface area (m²/g) | Volumetric surface area (m²/cm³) | Void fraction | Pore volume (cm³/g) | Largest cavity diameter (Å) | Pore limiting diameter (Å) |
|---|---|---|---|---|---|---|---|
| UMCM-152 | 0.57 | 4061 | 2306 | 0.79 | 1.4 | 13.9 | 6.8 |

In another variation, the natural gas storage material comprises a porous metal-organic framework material that is DUT-23-Cu. In certain variations, the usable methane storage capacity is greater than or equal to about 216 cm³ (STP)/cm³.

| Name | Density (g/cm³) | Gravimetric surface area (m²/g) | Volumetric surface area (m²/cm³) | Void fraction | Pore volume (cm³/g) | Largest cavity diameter (Å) | Pore limiting diameter (Å) |
|---|---|---|---|---|---|---|---|
| DUT-23-Cu | 0.41 | 4636 | 1916 | 0.82 | 2.0 | 20.3 | 7.9 |

In yet other variations, a natural gas storage material may include combinations of different MOFs. For example, in one variation, a natural gas storage material may comprise a porous metal-organic framework material having one or more sites for reversibly storing methane selected from the group consisting of: UMCM-152, DUT-23-Cu, and combinations thereof.

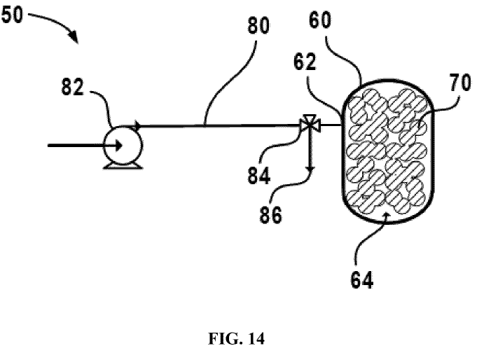

FIG. 14 shows a simplified diagram of a natural gas storage system 50 comprising a storage vessel 60 (e.g., a tank) having at least one port (e.g. inlet and outlet) 62 for fluid communication. While not shown, the storage vessel 60 may be stationary or mobile, for example, incorporated into a vehicle. The storage vessel 60 may have more than one port 62 depending on the storage vessel 60 design. The storage vessel 60 defines an interior storage cavity 64 in which a porous metal-organic framework material 70 is disposed. In certain aspects, the porous metal-organic framework material 70 has one or more sites for reversibly storing methane and having a useable methane storage capacity of greater than or equal to about 208 cm³ (STP)/cm³ under pressure swing conditions of 80 bar adsorption to 5 bar desorption at 298 K. The porous metal-organic framework material 70 is capable of reversibly storing a gas comprising methane (e.g., natural gas) via adsorption and desorption within the storage cavity 64 of the storage vessel 60.

As shown in FIG. 14, the natural gas storage system 50 also includes a conduit 80 for delivering gas to the port 62 of the storage vessel 60, which may have a compressor or pump 82 for pressurizing the gas prior to entering the storage vessel 60. Notably, the compressor or pump 82 and portions of the conduit 80 may be associated with a natural gas supply station (not shown). The pump 82 may thus intermittently be used to supply pressurized gas via conduit 80 to refuel the storage vessel 60. A three-way valve 84 may be disposed in the conduit 80 so that desorbed gas released from the porous metal-organic framework material 70 in the storage vessel 60 can be delivered in a fuel delivery conduit 86.

In certain other aspects, the present disclosure contemplates methods of reversibly storing a gas comprising methane. Any of the MOFs described above are suitable for use with such methods. In certain variations, the method may comprise contacting the gas comprising methane with a porous metal-organic framework (MOF) material having one or more sites for reversibly storing methane and having a usable methane storage capacity of greater than or equal to about 208 cm³(STP)/cm³ under pressure swing conditions of 80 bar adsorption to 5 bar desorption at 298 K. The contacting may occur where a first pressure (e.g., surrounding the MOF material and/or a pressure of the incoming gas to be adsorbed) is greater than or equal to about 65 bar for adsorbing methane molecules on the one or more sites of the MOF material. In certain variations, the contacting may occur where the first pressure of greater than or equal to about 80 bar. The methods may further comprise releasing the gas comprising methane by desorption from the porous metal-organic framework material by reducing to a second pressure of less than or equal to about 5 bar.

In other variations, the present disclosure contemplates methods of reversibly storing a gas comprising methane. The method comprises contacting the gas comprising methane at a first pressure with a porous metal-organic framework material having one or more sites for reversibly storing methane. The porous metal-organic framework material is selected from the group consisting of: catena-((µ8-5-(3,5-bis(4-carboxyphenyl)phenyl)benzene-1,3-dicarboxylato)-diaqua-di-copper] (UMCM-152), catena-(tetrakis(µ6-benzene- 1,3,5-tribenzoate)-tris(µ2-4,4′-bipyridine)-hexa-copper) (DUT 23 Cu), catena-[(µ4-Oxo)-tris(µ4-thieno[3,2-b]thiophene-2,5-dicarboxylato)-tetra-zinc] (VEBHUG or IRMOF-20), catena-[bis(dimethylammonium) (µ-triphenylene-2,3,6,7,10,11-hexolato)-vanadium dihydrate] (FUYCIN or V-CAT-5), catena-[(m-oxido)-tris(m-benzene-1,4-dicarboxylato)-tetra-zinc(ii)] (ja074366osi20070816_031204 or IRMOF-3), catena-[hexakis(dimethylammonium) disulfate tris(m2-oxalato)-di-zinc] (XIYYEL), bis(m2-N′-(3-hydroxy-2-oxybenzylidene)-2-hydroxybenzohydrazide)-tetrakis(pyridine)-di-manganese dinitrate methanol solvate (cg500192d_si_003 or porph@MOM-13), catena-(hexakis(m4-Benzene-1,4-dicarboxylato)-bis(m4-oxo)-octa-zinc solvate trihydrate (VUSKAW or MOF-5), catena-(hexakis(m4-Benzene-1,4-dicarboxylato)-bis(m4-oxo)-octa-zinc solvate) (VUSKEA or MOF-5), catena-(tris(m7-2,2′-(Adipoylbis(azanediyl))diterephthalato)-bis(m4-oxo)-octa-zinc chloroform dimethylformamide solvate) (PEVQOY or IRMOF-3-AM4XL), catena-(tris(m4-Benzene-1,4-dicarboxylato)-(m4-oxo)-tetra-zinc heptakis(N,N-diethylformamide) trihydrate clathrate) (EDUSIF or MOF-5), and combinations thereof.

The contacting may occur where a first pressure is greater than or equal to about 65 bar for adsorbing methane molecules on the one or more sites. In variations, the contacting may occur at the first pressure of greater than or equal to about 80 bar. The method may further comprise releasing the gas comprising methane by desorption from the porous metal-organic framework material by reducing to a second pressure of less than or equal to about 5 bar.

In certain variations, the porous metal-organic framework material is selected from the group consisting of: catena-[bis(dimethylammonium) (µ-triphenylene-2,3,6,7,10,11-hexolato)-vanadium dihydrate] (FUYCIN or V-CAT-5), and combinations thereof. In such a variation, the MOF has a usable methane storage capacity for methane/natural gas storage of greater than or equal to about 190 cm³(STP)/cm³ under pressure swing conditions of 65 bar adsorption to 5 bar desorption at 298 K.

In other variations, the porous metal-organic framework material is selected from the group consisting of: catena-((µ8-5-(3,5-bis(4-carboxyphenyl)phenyl)benzene-1,3-dicarboxylato)-diaqua-di-copper] (UMCM-152), catena-(tetrakis(µ6-benzene-1,3,5-tribenzoate)-tris(µ2-4,4′-bipyridine)-hexa-copper) (DUT 23 Cu), catena-[(µ4-Oxo)-tris(µ4-thieno[3,2-b]thiophene-2,5-dicarboxylato)-tetra-zinc] (VEBHUG or IRMOF-20), catena-[bis(dimethylammonium) (µ-triphenylene-2,3,6,7,10,11-hexolato)-vanadium dihydrate] (FUYCIN or V-CAT-5), catena-[(m-oxido)-tris(m-benzene-1,4-dicarboxylato)-tetra-zinc(ii)] (ja074366osi20070816_031204 or IRMOF-3), catena-[hexakis(dimethylammonium) disulfate tris(m2-oxalato)-di-zinc] (XIYYEL), bis(m2-N′-(3-hydroxy-2-oxybenzylidene)-2-hydroxybenzohydrazide)-tetrakis(pyridine)-di-manganese dinitrate methanol solvate (cg500192d_si_003 or porph@MOM-13), catena-(hexakis(m4-Benzene-1,4-dicarboxylato)-bis(m4-oxo)-octa-zinc solvate trihydrate (VUSKAW or MOF-5), catena-(hexakis(m4-Benzene-1,4-dicarboxylato)-bis(m4-oxo)-octa-zinc solvate) (VUSKEA or MOF-5), catena-(tris(m7-2,2′-(Adipoylbis(azanediyl))diterephthalato)-bis(m4-oxo)-octa-zinc chloroform dimethylformamide solvate) (PEVQOY or IRMOF-3-AM4XL), catena-(tris(m4-Benzene-1,4-dicarboxylato)-(m4-oxo)-tetra-zinc heptakis(N,N-diethylformamide) trihydrate clathrate) (EDUSIF or MOF-5), and combinations thereof. In such a variation, the MOF has a usable methane storage capacity for methane/natural gas storage of greater than or equal to about 200 cm³(STP)/cm³ under pressure swing conditions of 80 bar adsorption to 5 bar desorption at 298 K.

In a further variation, the porous metal-organic framework material is selected from the group consisting of: catena-((µ8-5-(3,5-bis(4-carboxyphenyl)phenyl)benzene-1,3-dicarboxylato)-diaqua-di-copper] (UMCM-152), catena-(tetrakis(µ6-benzene-1,3,5-tribenzoate)-tris(µ2-4,4′-bipyridine)-hexa-copper) (DUT-23-Cu), catena-[(µ₄-Oxo)-tris(µ₄-thieno[3,2-b]thiophene-2,5-dicarboxylato)-tetra-zinc] (VEBHUG or IRMOF-20), catena-[bis(dimethylammonium) (µ-triphenylene-2,3,6,7,10,11-hexolato)-vanadium dihydrate] (FUYCIN or V-CAT-5), catena-[(m-oxido)-tris(m-benzene-1,4-dicarboxylato)-tetra-zinc(ii)] (ja074366osi20070816_031204 or IRMOF-3), catena-[hexakis(dimethylammonium) disulfate tris(m2-oxalato)-di-zinc] (XIYYEL), catena-(hexakis(m4-Benzene-1,4-dicarboxylato)-bis(m4-oxo)-octa-zinc solvate) (VUSKEA or MOF-5), catena-(tris(m7-2,2′-(Adipoylbis(azanediyl))diterephthalato)-bis(m4-oxo)-octa-zinc chloroform dimethylformamide solvate) (PEVQOY or IRMOF-3-AM4XL), and combinations thereof. In such a variation, the MOF has a usable methane storage capacity for methane/natural gas storage of greater than or equal to about 202 cm³(STP)/cm³ under pressure swing conditions of 80 bar adsorption to 5 bar desorption at 298 K.

In yet another variations, the porous metal-organic framework material is selected from the group consisting of: catena-((µ8-5-(3,5-bis(4-carboxyphenyl)phenyl)benzene-1,3-dicarboxylato)-diaqua-di-copper] (UMCM-152), catena-(tetrakis(µ6-benzene-1,3,5-tribenzoate)-tris(µ2-4,4′-bipyridine)-hexa-copper) (DUT 23 Cu), and combinations thereof. In such a variation, the MOF has a usable methane storage capacity for methane/natural gas storage of greater than or equal to about 216 cm³(STP)/cm³ under pressure swing conditions of 80 bar adsorption to 5 bar desorption at 298 K.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A natural gas storage material comprising:
a porous metal-organic framework material having one or more sites for reversibly storing methane and having a usable methane storage capacity of greater than or equal to about 208 cm³(STP)/cm³ under pressure swing conditions of 80 bar adsorption to 5 bar desorption at 298 K.

2. The natural gas storage material of claim 1, wherein the porous metal-organic framework material has a gravimetric surface area of greater than or equal to about 2,000 m²/g.

3. The natural gas storage material of claim 1, wherein the porous metal-organic framework material has a pore volume of greater than or equal to about 1 cm³/g to less than or equal to about 2.2 cm³/g.

4. The natural gas storage material of claim 1, wherein the porous metal-organic framework material comprises pores having an average pore diameter of greater than or equal to about 7 Angstrom to less than or equal to about 20 Angstrom.

5. The natural gas storage material of claim 1, wherein the porous metal-organic framework material has a volumetric surface area of greater than or equal to about 1,800 m²/cm³ to less than or equal to about 2,700 m²/cm³.

6. The natural gas storage material of claim 1, wherein the porous metal-organic framework material has a single crystal density of greater than or equal to about 0.4 g/cm³ to less than or equal to about 1 g/cm³.

7. The natural gas storage material of claim 1, wherein the porous metal-organic framework material has a void fraction of greater than or equal to about 0.7 to less than or equal to about 0.85.

8. The natural gas storage material of claim 1, wherein the porous metal-organic framework material is catena-((µ8-5-(3,5-bis(4-carboxyphenyl)phenyl)benzene-1,3-dicarboxylato)-diaqua-di-copper](UMCM-152) or catena-(tetrakis(µ6-benzene-1,3,5-tribenzoate)-tris(µ2-4,4′-bipyridine)-hexa-copper) (DUT-23-Cu).

9. The natural gas storage material of claim 1, wherein the usable methane storage capacity is greater than or equal to about 216 cm³(STP)/cm³.

10. The natural gas storage material of claim 1, wherein the metal-organic framework is activated by treatment with supercritical carbon dioxide (CO₂).

11. The natural gas storage material of claim 1, wherein the gas comprises a mixture of methane and at least one other gas.

12. The natural gas storage material of claim 11, wherein the gas is derived from natural gas.

13. A natural gas storage material comprising:
a porous metal-organic framework material having one or more sites for reversibly storing methane selected from the group consisting of: catena-(([t8-5-(3,5-bis(4-carboxyphenyl)phenyl)benzene-1,3-dicarboxylato)-diaqua-di-copper](UMCM-152), catena-(tetrakis(µ6-benzene-1,3,5-tribenzoate)-tris(µ2-4,4′-bipyridine)-hexa-copper) (DUT 23 Cu), catena-[(µ4-Oxo)-tris(µ4-thieno[3,2-b]thiophene-2,5-dicarboxylato)-tetra-zinc] (VEBHUG or IRMOF-20), catena-[bis(dimethylammonium) (µ-triphenylene-2,3,6,7,10,11-hexolato)-vanadium dihydrate] (FUYCIN or V-CAT-5), catena-[(m-oxido)-tris(m-benzene-1,4-dicarboxylato)-tetra-zinc(ii)] (ja074366osi20070816_031204 or IRMOF-3), catena-[hexakis(dimethylammonium) disulfate tris(m2-oxalato)-di-zinc] (XIYYEL), bis(m2-N′-(3-hydroxy-2-oxybenzylidene)-2-hydroxybenzohydrazide)-tetrakis(pyridine)-di-manganese dinitrate methanol solvate (cg500192d_si_003 or porph@MOM-13), catena-(hexakis(m4-Benzene-1,4-dicarboxylato)-bis(m4-oxo)-octa-zinc solvate trihydrate (VUSKAW or MOF-5), catena-(hexakis(m4-Benzene-1,4-dicarboxylato)-bis(m4-oxo)-octa-zinc solvate) (VUSKEA or MOF-5), catena-(tris(m7-2,2′-(Adipoylbis(azanediyl))diterephthalato)-bis(m4-oxo)-octa-zinc chloroform dimethylformamide solvate) (PEVQOY or IRMOF-3-AM4XL), catena-(tris(m4-Benzene-1,4-dicarboxylato)-(m4-oxo)-tetra-zinc heptakis(N,N-diethylformamide) trihydrate clathrate) (EDUSIF or MOF-5), and combinations thereof.

14. The natural gas storage material of claim 13, wherein the porous metal-organic framework material is selected from the group consisting of: catena-[bis(dimethylammonium) (µ-triphenylene-2,3,6,7,10,11-hexolato)-vanadium dihydrate] (FUYCIN or V-CAT-5), and combinations thereof.

15. The natural gas storage material of claim 13, wherein the porous metal-organic framework material is selected from the group consisting of: catena-((µ8-5-(3,5-bis(4-carboxyphenyl)phenyl)benzene-1,3-dicarboxylato)-diaqua-di-copper] (UMCM-152), catena-(tetrakis(µ6-benzene-1,3,5-tribenzoate)-tris(µ2-4,4′-bipyridine)-hexa-copper) (DUT 23 Cu), catena-[(µ4-Oxo)-tris(µ4-thieno[3,2-b]thiophene-2,5-dicarboxylato)-tetra-zinc] (VEBHUG or IRMOF-20), catena-[bis(dimethylammonium) (µ-triphenylene-2,3,6,7,10,11-hexolato)-vanadium dihydrate] (FUYCIN or V-CAT-5), catena-[(m-oxido)-tris(m-benzene-1,4-dicarboxylato)-tetra-zinc(ii)] (ja074366osi20070816_031204 or IRMOF-3), catena-[hexakis(dimethylammonium) disulfate tris(m2-oxalato)-di-zinc] (XIYYEL), bis(m2-N′-(3-hydroxy-2-oxybenzylidene)-2-hydroxybenzohydrazide)-tetrakis(pyridine)-di-manganese dinitrate methanol solvate (cg500192d_si_003 or porph@MOM-13), catena-(hexakis(m4-Benzene-1,4-dicarboxylato)-bis(m4-oxo)-octa-zinc solvate trihydrate (VUSKAW or MOF-5), catena-(hexakis(m4-Benzene-1,4-dicarboxylato)-bis(m4-oxo)-octa-zinc solvate) (VUSKEA or MOF-5), catena-(tris(m7-2,2′-(Adipoylbis(azanediyl))diterephthalato)-bis(m4-oxo)-octa-zinc chloroform dimethylformamide solvate) (PEVQOY or IRMOF-3-AM4XL), catena-(tris(m4-Benzene-1,4-dicarboxylato)-(m4-oxo)-tetra-zinc heptakis(N,N-diethylformamide) trihydrate clathrate) (EDUSIF or MOF-5), and combinations thereof.

16. The natural gas storage material of claim 13, wherein the porous metal-organic framework material is selected from the group consisting of: catena-((µ8-5-(3,5-bis(4-carboxyphenyl)phenyl)benzene-1,3-dicarboxylato)-diaqua-di-copper](UMCM-152), catena-(tetrakis(µ6-benzene-1,3,5-tribenzoate)-tris(µ2-4,4′-bipyridine)-hexa-copper) (DUT-23-Cu), catena-[(µ4-Oxo)-tris(µ4-thieno[3,2-b]thiophene-2,5-dicarboxylato)-tetra-zinc] (VEBHUG or IRMOF-20), catena-[bis(dimethylammonium) (µ-triphenylene-2,3,6,7,10,11-hexolato)-vanadium dihydrate] (FUYCIN or V-CAT-5), catena-[(m-oxido)-tris(m-benzene-1,4-dicarboxylato)-tetra-zinc(ii)] (ja074366osi20070816_031204 or IRMOF-3), catena-[hexakis(dimethylammonium) disulfate tris(m2-oxalato)-di-zinc] (XIYYEL), catena-(hexakis(m4-Benzene-1,4-dicarboxylato)-bis(m4-oxo)-octa-zinc solvate) (VUSKEA or MOF-5), catena-(tris(m7-2,2′-(Adipoylbis(azanediyl))diterephthalato)-bis(m4-oxo)-octa-zinc chloroform dimethylformamide solvate) (PEVQOY or IRMOF-3-AM4XL), and combinations thereof.

17. The natural gas storage material of claim 13, wherein the porous metal-organic framework material is selected from the group consisting of: catena-((µ8-5-(3,5-bis(4-carboxyphenyl)phenyl)benzene-1,3-dicarboxylato)-diaqua-di-copper] (UMCM-152), catena-(tetrakis(µ6-benzene-1,3,5-tribenzoate)-tris(µ2-4,4′-bipyridine)-hexa-copper) (DUT 23 Cu), and combinations thereof.

18. A natural gas storage system comprising:
a vessel having at least one port for fluid communication and a storage cavity; and
a porous metal-organic framework material disposed in storage cavity of the vessel, the porous metal-organic framework material having one or more sites for reversibly storing methane and having a usuable methane storage capacity of greater than or equal to about 208 cm³(STP)/cm³ under pressure swing conditions of 80 bar adsorption to 5 bar desorption at 298, wherein the porous metal-organic framework material is capable of reversibly storing a gas comprising methane via adsorption and desorption within the storage cavity of the vessel.

19. The natural gas storage system of claim 18, wherein the porous metal-organic framework material is catena-((µ8-5-(3,5-bis(4-carboxyphenyl)phenyl)benzene-1,3-dicarboxylato)-diaqua-di-copper](UMCM-152) or catena-(tetrakis(µ6-benzene-1,3,5-tribenzoate)-tris(µ2-4,4′-bipyridine)-hexa-copper) (DUT-23-Cu).

20. The natural gas storage system of claim 18, wherein the usable methane storage capacity is greater than or equal to about 216 cm³(STP)/cm³.
